(19) United States
(12) Patent Application Publication
(10) Pub. No.: US 2025/0370696 A1
(43) Pub. Date: Dec. 4, 2025

(54) DISPLAY DEVICE AND DISPLAY SYSTEM

(71) Applicant: Samsung Electronics Co., Ltd., Suwon-si (KR)

(72) Inventors: Sukhoon YOON, Suwon-si (KR); Kwanyoung KIM, Suwon-si (KR); Minsup KIM, Suwon-si (KR); Kihyun SONG, Suwon-si (KR); Wonjae LEE, Suwon-si (KR); Jongkeun LEE, Suwon-si (KR)

(21) Appl. No.: 19/299,838

(22) Filed: Aug. 14, 2025

Related U.S. Application Data
(63) Continuation of application No. PCT/KR2023/021466, filed on Dec. 22, 2023.

(30) Foreign Application Priority Data
Feb. 15, 2023 (KR) 10-2023-0020350

(51) Int. Cl. G06F 3/14

(52) U.S. Cl. CPC G06F 3/1454

(57) ABSTRACT

A display device and/or a display system may include a plurality of display devices; and an access point (AP) connected to the plurality of display devices. A display device of the plurality of display devices may be configured to receive received signal strength indicator (RSSI) information of the plurality of display devices from the AP, and display identification information of the plurality of display devices based on the received RSSI information of the plurality of display devices.

### CROSS-REFERENCE TO RELATED APPLICATIONS

This application is a continuation application of International Application No. PCT/KR2023/021466, filed on Dec. 22, 2023, in the Korean Intellectual Property Receiving Office, and claiming priority to Korean Patent Application No. 10-2023-0020350 filed Feb. 15, 2023, the disclosures of which are all hereby incorporated by reference herein in their entireties.

### TECHNICAL FIELD

Certain example embodiments may relate to a display device and/or a display system for sharing content information.

### BACKGROUND

Recently, the rapid development of wired and wireless data communication technologies and the widespread propagation of communication networks have led to the popularization of high-speed communication services such as the Internet.

In particular, as the high-speed Internet has become widespread in homes, a PC-based network building technology has evolved into home network technology to enable remote control of digital home appliances within the home.

A home network system is a system that connects digital home appliances, sensors, lighting, heating and cooling devices, gas devices, etc. which are installed in a home, to a short-range wired network or wireless network, allowing a user to control desired appliances regardless of time or place.

The home network system may include a display device that outputs video.

A plurality of display devices may be interconnected through the home network to share video information.

Recently, as the types of the display device have increased, there has been difficulty in recognizing the display device to be shared.

### SUMMARY

An example embodiment may provide a display device that displays identification information, location information, and state information of a plurality of display devices connected, directly or indirectly, to an access point, and a display system including the display device.

Another example embodiment may provide a display device that transmits content information being output from one of a plurality of display devices connected to an access point to another display device, and a display system including the display device.

According to an example embodiment, a display device may include: a display; communication circuitry configured to communicate with an access point (AP) and a plurality of display devices connected, directly or indirectly, to the AP; and at least one processor, comprising processing circuitry, individually and/or collectively configured to control the display to display identification information of the plurality of display devices based on received signal strength indicator (RSSI) information of the plurality of display devices received from the AP.

According to an example embodiment, the at least one processor of the display device may be individually and/or collectively configured to obtain distance information between the AP and each of the plurality of display devices based on the received RSSI information of the plurality of display devices, and control the display to display the identification information of the plurality of display devices based on the obtained distance information.

According to an example embodiment, the at least one processor of the display device may be individually and/or collectively configured to confirm display positions corresponding to the distance information between the AP and each of the plurality of display devices, and control the display to display the identification information of the plurality of display devices based on information about the confirmed display positions.

According to an example embodiment, the at least one processor of the display device may be individually and/or collectively configured to control the display to display a plurality of circular guide lines, and to display the identification information of the plurality of display devices on each of the plurality of guide lines based on the distance information between the AP and each of the plurality of display devices. The plurality of circular guide lines may have different diameters. A center of the plurality of circular guide lines may indicate a location of the AP.

According to an example embodiment, the at least one processor of the display device may be individually and/or collectively configured to communicate with a remote controller configured to receive a user input. The at least one processor may be individually and/or collectively configured to adjust at least one of a location of the identification information of the plurality of display devices displayed on the plurality of circular guide lines based on the user input.

According to an example embodiment, the identification information of the plurality of display devices may include at least one of model information, space name information, or device name information of each of the plurality of display devices.

According to an example embodiment, the at least one processor of the display device may be individually and/or collectively configured to change the model information of the plurality of display devices to the space name information and device name information based on a user input.

According to an example embodiment, the at least one processor of the display device may be individually and/or collectively configured to transmit sharing proposal information to the plurality of display devices, among the plurality of display devices, set a display device transmitting sharing approval information as a shareable display device, and set a display device transmitting sharing rejection information as a non-shareable display device.

According to an example embodiment, the at least one processor of the display device may be individually and/or collectively configured to, based on receiving viewing proposal information for content sharing through an input or a remote controller, encode content information being output through the display, and control to transmit the encoded content information and electronic program guide (EPG) information to the shareable display device.

According to an example embodiment, the at least one processor of the display device may be individually and/or collectively configured to, based on receiving viewing approval information from the shareable display device, transmit the content information, and based on receiving viewing rejection information from the shareable display device, confirm an end time of content based on the EPG information and record the content information based on the confirmed end time.

According to an example embodiment, the at least one processor of the display device may be individually and/or collectively configured to control the display to display a main image and display a plurality of sub images on the main image. Each of the plurality of sub images may display state information and identification information of a display device to which each of the plurality of sub images is matched.

According to an example embodiment, the at least one processor of the display device may be individually and/or collectively configured to adjust at least one of a marking, color, brightness, or transparency of the plurality of sub images based on the state information of each of the plurality of display devices. The state information may include a shareable state, a non-shareable state, an on state, an off state, and a content output state,

According to an example embodiment, the at least one processor of the display device may be individually and/or collectively configured to confirm a display device being in the on state, confirm a sub image corresponding to the confirmed display device from among the plurality of sub images, and control the display to display content information being output from the confirmed display device on the confirmed sub image.

According to an example embodiment, a display system may include: a plurality of display devices; and an access point (AP) connected to the plurality of display devices. According to an example embodiment, a display device of the plurality of display devices may be configured to receive RSSI information of the plurality of display devices from the AP, and display identification information of the plurality of display devices based on the received RSSI information of the plurality of display devices.

According to an example embodiment, the display device of the display system may be configured to obtain distance information between the AP and each of the plurality of display devices based on the received RSSI information of the plurality of display devices, and display the identification information of the plurality of display devices based on the obtained distance information. The identification information of the plurality of display devices may include at least one of model information, space name information, or device name information of each of the plurality of display devices.

According to an example embodiment, the display device of the display system may be configured to adjust at least one of display positions of the identification information of the plurality of display devices based on a user input received through an input or a remote controller, and change identification information of at least one of the plurality of display devices from model information to the space name information and the device name information based on the user input.

According to an example embodiment, the display device of the display system may be configured to transmit sharing proposal information to remaining display devices excluding the display device from among the plurality of display devices, set a display device transmitting sharing approval information as a shareable display device, and set a display device transmitting sharing rejection information as a non-shareable display device. The remaining display devices of the display system may be configured to display a popup in response to receiving the sharing proposal information, and transmit the sharing approval information or the sharing rejection information corresponding to a user input to the display device.

According to an example embodiment, the display device of the display system may be configured to, based on receiving viewing proposal information for content sharing through an input or a remote controller, encode content information being output through the display, and transmit the encoded content information and electronic program guide (EPG) information to the shareable display device. According to an example embodiment, the shareable display device of the display system may be configured to output the viewing proposal information and the encoded content information as a popup, and transmit viewing approval information or viewing rejection information corresponding to a user input to the display device.

According to an example embodiment, the display device of the display system may be configured to display a main image and display a plurality of sub images on the main image. Each of the plurality of sub images may display state information and identification information of a display device to which each of the plurality of sub images is matched.

According to an example embodiment, the display device of the display system may be configured to adjust at least one of a marking, color, brightness, or transparency of the plurality of sub images based on the state information of the remaining display devices. The state information may include a shareable state, a non-shareable state, an on state, an off state, and a content output state.

According to certain example embodiments, identification information, location information, and/or state information of a plurality of display devices connected to an access point may be displayed, enabling a user to intuitively recognize a location of each of the plurality of display devices.

According to certain example embodiments, a user may easily recognize a location of each of the plurality of display devices and easily recognize a shareable display device, allowing the user to select a display device that the user desires to share easily and conveniently.

According to certain example embodiments, content information being output from one display device may be encoded and the encoded content information and electronic program guide (EPG) information may be transmitted to another display device, enabling a user of the other display device to easily recognize shareable content.

According to certain example embodiments, in a case where a response to a viewing proposal for content is not received or a rejection response is received from another display device, the content to be shared may be recorded and provided to users using other display devices at a later time.

Thus, an improved sharing service may be provided to the users and user satisfaction may be increased.

### BRIEF DESCRIPTION OF DRAWINGS

FIG. 1 is a diagram illustrating a home network system including a display device according to an example embodiment.

FIG. 2 is a diagram illustrating an example of a display system according to an example embodiment.

FIG. 3 is a control block diagram of a display device according to an example embodiment.

FIG. 4A, FIG. 4B, FIG. 4C, FIG. 4D, and FIG. 4E are diagrams illustrating examples of displaying identification information on a display device according to an example embodiment(s).

FIG. 5A, FIG. 5B, and FIG. 5C are diagrams illustrating examples of sharing settings on a display device according to an example embodiment(s).

FIG. 6A and FIG. 6B are diagrams illustrating examples of displaying a main image and a sub image on a display device according to an example embodiment(s).

FIG. 7A, FIG. 7B, FIG. 7C, FIG. 7D, and FIG. 7E are diagrams illustrating examples of sub image change on a display device according to an example embodiment(s).

FIG. 8 is a diagram illustrating an example of a popup for sharing settings on a display device according to an example embodiment.

FIG. 9A and FIG. 9B are diagrams illustrating examples of a popup for a viewing proposal on a display device according to an example embodiment.

FIG. 10 is a diagram illustrating an example of a popup that guides the viewing of recorded content on a display device according to an example embodiment.

FIG. 11 is a diagram illustrating an example of a popup that guides cancellation of a viewing proposal on a display device according to an example embodiment.

FIG. 12 is a control block diagram of an access point provided in a display system according to an example embodiment.

FIG. 13 is a control flowchart of displaying a list of display devices of a display system according to an example embodiment.

FIG. 14 is a control flowchart illustrating sharing settings of display devices of a display system according to an example embodiment.

FIG. 15A and FIG. 15B are control flowcharts illustrating content sharing and viewing on display devices of a display system according to an example embodiment.

### DETAILED DESCRIPTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through at least a third element(s).

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

As used herein, the term “and/or” includes any and all combinations of one or more of the associated listed items.

Hereinafter, the principles of operation and embodiments of the disclosure is described with reference to the accompanying drawings.

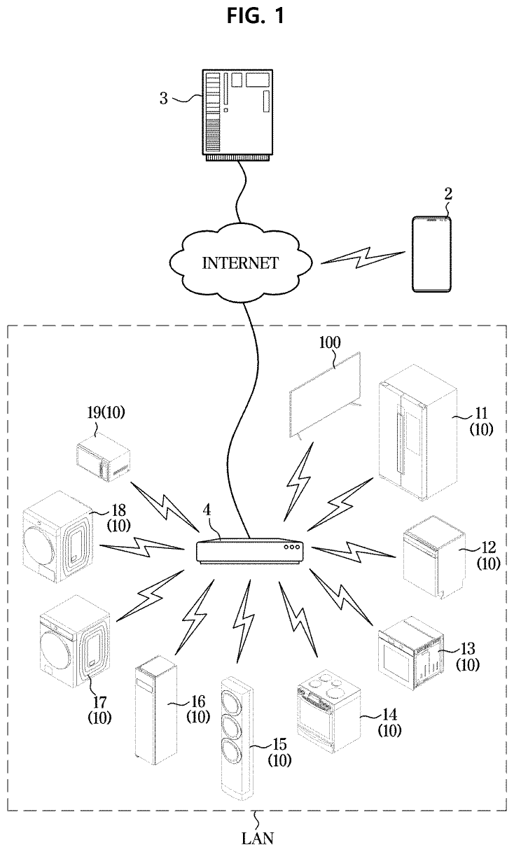

FIG. 1 is a diagram illustrating a home network system including a display device according to an embodiment,

A home appliance 10 may include a communication module capable of communicating with another home appliance, a user device 2, or a server 3, a user interface that receives a user input or outputs information to a user, at least one processor that controls an operation of the home appliance 10, and at least one memory that stores a program for controlling the operation of the home appliance 10.

The home appliance 10 may be at least one of various types of home appliances. For example, as shown in the accompanying drawings, the home appliance 10 may include a refrigerator 11, a dishwasher 12, an electric range 13, an electric oven 14, an air conditioner 15, a clothes treating apparatus 16, a washing machine 17, a dryer 18, and a microwave oven 19, but is not limited thereto. For example, the home appliance 10 may include various types of appliances not shown in the drawings, such as a cleaning robot, a vacuum cleaner, a display device 100 such as a television, and the like. Furthermore, the aforementioned home appliances are by way of example only, and in addition to the aforementioned home appliances, other appliances connected to other home appliance, the user device 2, or the server 3 to perform operations described below may be included in the home appliance 10 according to an embodiment.

The server 3 may include a communication module, comprising communication circuitry, communicating with another server, the home appliance 10, or the user device 2, at least one processor that processes data received from another server, the home appliance 10, or the user device 2, and at least one memory that stores programs for processing data or processed data. The server 3 may be implemented as a variety of computing devices, such as a workstation, a cloud, a data drive, a data station, and the like. The server 3 may be implemented as one or more server physically or logically separated based on a function, detailed configuration of function, or data, and may transmit and receive data through communication between servers and process the transmitted and received data.

The server 3 may perform functions, such as managing a user account, registering the home appliance 10 in association with the user account, managing or controlling the registered home appliance 10, and the like. For example, a user may access the server 3 via the user device 2 and may create a user account. The user account may be identified by an identifier (ID) and a password set by the user. The server 3 may register the home appliance 10 with the user account according to a predetermined procedure. For example, the server 3 may link identification information of the home appliance 10 (e.g., a serial number or MAC address) to the user account to register, manage, and control the home appliance 10. The user device 2 may include a communication module capable of communicating with the server 3, a user interface that receives a user input or outputs information to a user, at least one processor that controls an operation of the user device 2, and at least one memory that stores a program for controlling the operation of the user device 2.

The user device 2 may be carried by a user, or placed in a user's home or office, or the like. The user device 2 may include a personal computer (PC), a terminal, a portable telephone, a smartphone, a handheld device, a wearable device, and the like, but is not limited thereto.

The user device 2 is a device capable of displaying images and may be included in the display device 100.

The memory of the user device 2 may store a program for controlling the home appliance 10, e.g. an application. The application may be sold installed on the user device 2, or may be downloaded from an external server for installation.

By running the application installed on the user device 2 by a user, the user may access the server 3, create a user account, and communicate with the server 3 based on the login user account to register the home appliance 10.

For example, by operating the home appliance 10 to allow the home appliance 10 to access the server 3 according to a procedure guided by the application installed on the user device 2, the server 3 may register the home appliance 10 with the user account by assigning the identification information (e.g., a serial number or a MAC address) of the home appliance 10 to the corresponding user account.

A user may control the home appliance 10 using the application installed on the user device 2. For example, by logging into a user account with the application installed on the user device 2, the home appliance 10 registered in the user account appears, and by inputting a control command for the home appliance 10, the control command may be delivered to the home appliance 10 via the server 3.

A network may include both a wired network and a wireless network. The wired network may include a cable network or a telephone network, and the wireless network may include any networks transmitting and receiving a signal via radio waves. The wired network and the wireless network may be interconnected.

The network may include a wide area network (WAN), such as the Internet, a local area network (LAN) formed around an access point (AP), and a short-range wireless network that does not use an AP. The short-range wireless network may include Bluetooth™ (IEEE 802.15.1), Zigbee (IEEE 802.15.4), Wi-Fi Direct, near field communication (NFC), and Z-Wave, but is not limited thereto.

The AP may connect the home appliance 10 or the user device 2 to a WAN connected to the server 3. The home appliance 10 or the user device 2 may be connected to the server 3 via a WAN.

The AP may communicate with the home appliance 10 or the user device 2 using wireless communication, such as Wi-Fi (IEEE 802.11), Bluetooth™ (IEEE 802.15.1), Zigbee (IEEE 802.15.4), and the like, and access a WAN using wired communication, but is not limited thereto.

According to various embodiments, the home appliance 10 may be directly connected, directly or indirectly, to the user device 2 or the server 3 without going through an AP.

The home appliance 10 may be connected to the user device 2 or the server 3 via a long-range wireless network or a short-range wireless network.

For example, the home appliance 10 may be connected to the user device 2 via a short-range wireless network (e.g., Wi-Fi Direct).

In another example, the home appliance 10 may be connected to the user device 2 or the server 3 via a WAN using a long-range wireless network (e.g., a cellular communication module).

In still another example, the home appliance 10 may access a WAN using wired communication, and may be connected to the user device 2 or the server 3 via a WAN.

When accessing a WAN using wired communication, the home appliance 10 may also act as an AP. Accordingly, the home appliance 10 may connect another home appliance 10 to a WAN to which the server 3 is connected. In addition, another home appliance may connect the home appliance 10 to the WAN to which the server 3 is connected.

The home appliance 10 may transmit information about an operation or state to other home appliances, the user device 2, or the server 3 via the network. For example, the home appliance 10 may transmit information about an operation or state to other home appliances, the user device 2 or the server 3 upon receiving a request from the server 3, in response to an event in the home appliance 10, or periodically or in real time. Upon receiving the information about the operation or state from the home appliance 10, the server 3 may update the stored information about the operation or state of the home appliance 10 and transmit the updated information about the operation and state of the home appliance 10 to the user device 2 via the network. Here, updating the information may include various operations in which existing information is changed, such as adding new information to the existing information, replacing the existing information with new information, and the like.

The home appliance 10 may obtain various information from other home appliances, the user device 2, or the server 3, and may provide the obtained information to a user. For example, the home appliance 10 may obtain information related to a function of the home appliance 10 (e.g., recipes, washing instructions, etc.) from the server 3 and various environmental information (e.g., weather, temperature, humidity, etc.), and may output the obtained information via a user interface.

The home appliance 10 may operate in accordance with a control command received from other home appliances, the user device 2, or the server 3. For example, the home appliance 10 may operate in accordance with a control command received from the server 3, based on a prior authorization obtained from a user to operate in accordance with the control command of the server 3 even without a user input. Here, the control command received from the server 3 may include a control command input by the user via the user device 2 or a control command based on preset conditions, but is not limited thereto.

The user device 2 may transmit information about a user to the home appliance 10 or the server 3 via the communication module. For example, the user device 2 may transmit information about a user's location, a user's health condition (e.g., state), a user's preference, a user's schedule, and the like to the server 3. The user device 2 may transmit information about the user to the server 3 based on the user's prior authorization.

The home appliance 10, the user device 2, or the server 3 may use techniques, such as artificial intelligence (AI) to determine a control command. For example, the server 3 may receive information about an operation or a state of the home appliance 10 or information about a user of the user device 2, process the received information using techniques, such as AI, and transmit a processing result or a control command to the home appliance 10 or the user device 2 based on the processing result.

A display system according to the embodiments of the disclosure may be any system including an AP and at least two display devices.

A display device according to the embodiments of the disclosure may be any device capable of displaying content images and performing communications.

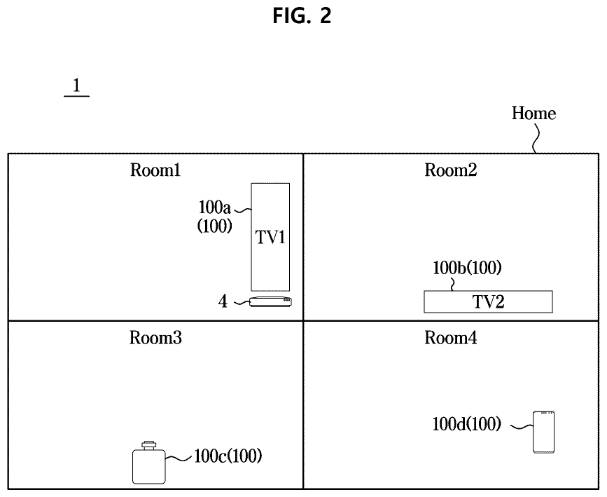

FIG. 2 is a diagram illustrating an example of a display system according to an embodiment.

The display system 1 may include a plurality of display devices (100: 100a, 100b, 100c, and 100d) and an access point (AP, 4).

The plurality of display devices may include display devices whose locations are fixed. For example, the display devices whose locations are fixed may include a television (TV), a projector, a kitchen display system, and a personal computer (PC).

The plurality of display devices may further include a display device that is easy to move and portable. For example, the display device that is easy to move and portable may be a mobile device. The mobile device may include a terminal, a portable telephone, a smart phone, a handheld device, a wearable device, a notebook, and a tablet PC.

The plurality of display devices may further include a display device provided in a refrigerator, a washing machine, a dryer, and the like.

The plurality of display devices (100: 100a, 100b, 100c, and 100d) may be disposed within a home.

The plurality of display devices (100: 100a, 100b, 100c, and 100d) may be disposed in different spaces within the home.

Hereinafter, for convenience of description, the plurality of display devices (100: 100a, 100b, 100c, and 100d) are described as the first display device 100a, the second display device 100b, the third display device 100c, and the fourth display device 100d.

The home may include one or more spaces. The two or more spaces within the home may be spaces separated by walls and doors, and may be independent of each other.

Each space within the home may be a room.

As shown in FIG. 2, the first display device 100a may be disposed in the first room Room1, the second display device 100b may be disposed in the second room Room2, the third display device 100c may be disposed in the third room Room3, and the fourth display device 100d may be disposed in the third room Room3.

For example, the first display device 100a may be a first television, the second display device 100b may be a second television, the third display device 100c may be a projector, and the fourth display device 100d may be a mobile device.

The mobile device 100d may be a device capable of setting up an application provided by a content provider, or a device in which an application (e.g., app) or software or firmware is embedded by a manufacturer during manufacturing.

The first and second televisions may also be devices capable of setting up an application provided by a content provider, or devices in which an application (e.g., app) or software or firmware is embedded by a manufacturer during manufacturing,

The content refers to a combination of digitized text, audio, and video, and may include at least one of a photograph, music, video, or document.

The first display device 100a, the second display device 100b, the third display device 100c, and the fourth display device 100d are disposed in different spaces within the home, and may perform communication with each other through the network of the home.

The network of the home may allow information to be shared among a plurality of home appliances via wired and wireless Internet.

The network may include a wide area network (WAN) such as the Internet, a local area network (LAN) formed around the access point (AP, 4), and a short-range wireless network that does not pass through the AP.

The short-range wireless network may include, but is not limited to, Bluetooth™ (IEEE 802.15.1), Zigbee (IEEE 802.15.4), Wi-Fi Direct, near field communication (NPC), Z-Wave, radio frequency (RF), infrared data association (IrDA), and infrared (IR).

The AP 4 may connect the home appliance 10, the user device 2, and at least one display device 100 to the wide area network (WAN) to which the server 3 is connected.

The home appliance 10, the user device 2, and at least one display device 100 may be connected to the server 3 via the wide area network (WAN).

The AP may perform communication with the home appliance 10, the user device 2, and the plurality of display devices 100 using wireless communication such as Wi-Fi™ (IEEE 802.11), Bluetooth™ (IEEE 802.15.1), Zigbee (IEEE 802.15.4).

The AP 4 may connect the home appliance 10, the user device 2, and at least one display device 100 to the wide area network (WAN) using wired communication, but is not limited thereto.

The AP 4 may be connected, directly or indirectly, to the home network to perform home networking.

The AP 4 may perform communication with the plurality of display devices 100 located in the home. The AP 4 may also perform communication with at least one home appliance 10 located in the home.

The AP 4 may perform communication with the plurality of display devices 100 located within a preset distance. Here, the preset distance may be a distance corresponding to the size of the home.

The AP 4 may allow the plurality of display devices 100 used in the home to be connected as a single system, and to enable bidirectional communication with the plurality of display devices 100.

The AP 4 may not only allow the plurality of display devices 100 used in the home but also at least one home appliance 10 used in the home to be connected as a single system, and to enable bidirectional communication with at least one home appliance 10.

The AP 4 may allow at least one home appliance and at least one of the plurality of display devices 100 to be connected to an external device via a network.

The external device may include the server 3 and may include the user device 2.

For example, the server 3 may include a broadcasting station server, a telecommunications company server, a content provider server, and an application provider server.

The user device 2 herein may be a device of another user excluding the user of the plurality of display devices in the home.

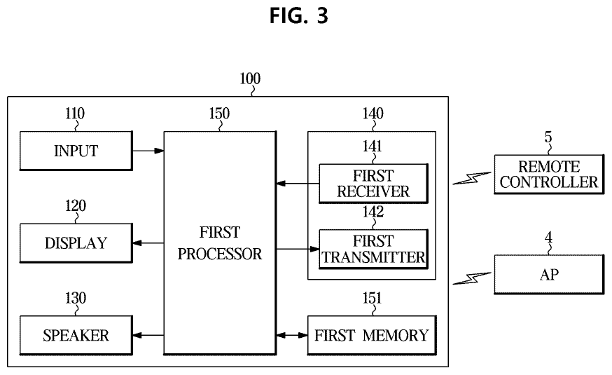

FIG. 3 is a control block diagram of a display device according to an embodiment.

The display device 100 includes an input 110, a display 120, a speaker 130, first communication circuitry 140, a first processor 150, and a first memory 151.

To distinguish between components (elements) of the display device 100 and components of the AP 4 that have the same name, ‘first’ is written for the components of the display device, and ‘second’ is written for the components of the access point.

The configurations of the plurality of display device 100a, 100b, 100c, and 100d may be identical to each other. That is, each of the plurality of display device 100a, 100b, 100c, and 100d may include the input 110, the display 120, the speaker 130, the first communication circuitry 140, the first processor 150, and the first memory 151. Accordingly, the control configuration of the first display device 100a is described as a representative example.

The first display device 100a includes the input 110, the display 120, the speaker 130, the first communication circuitry 140, the first processor 150, and the first memory 151.

The input 110 receives a user input.

The user input includes a network search command, network selection information, sharing setting information, and identification information of the display device, and may include selection information of a display device to be shared and viewing proposal information.

The user input may include a preview command, a viewing approval command, a viewing rejection command, a command to view a list of recorded content, selection information for recorded content, a command to play recorded content, and a command to delete recorded content. The user input may also include an approval command (OK, Yes), a rejection command (No), and an end command for a popup.

The identification information of the display device may include space name information and device name information.

The identification information of the display device may include model name information of a display device.

The user input may include an on command and an off command of the first display device, and may include content selection information.

The user input may include a selection command for a main mode and a sub mode for content sharing.

The main mode is a mode in which content information being output from the first display device 100a is provided to another display device. In this case, the first display device 100a may be a main display device, and the other display device may be a sub display device.

The sub mode is a mode in which content information is received from another display device. In this case, the other display device may be a main display device.

The input 110 may include hardware devices, such as various types of buttons or switches, a pedal, a keyboard, a mouse, a track-ball, various levers, a handle, or a stick.

In addition, the input 110 may also include a software device, e.g., a graphical user interface (GUI) device such as a touch pad. The touch pad may be implemented as a touch screen panel (TSP) and may form a mutual layer structure with the display.

In a case where the input 110 is configured as a TSP forming a mutual layer structure with the touch pad, the display may also serve as the input.

The display 120 may display an image (video) corresponding to a control command of the first processor 150.

The display 120 may display the content information selected by a user as an image.

The display 120 may display input information corresponding to the user input.

The display 120 may display an image corresponding to network selection and an image corresponding to sharing settings.

The display 120 may display the identification information of the first display device and identification information of another display device, and may display distance information of the first display device and distance information of the other display device centered on a location of the AP 4.

The display 120 may display location information of a plurality of display devices. The location information of the plurality of display devices may correspond to space information about where the plurality of display devices are located in the home.

The display 120 may display state information of another display device.

The state information of the other display device may include an on state, an off state, a shareable state, a non-shareable state, and information about content being output.

The display 120 may display content video being output from the first display device 100a as a main image, and display the state information of the other display device as a sub image.

The display 120 may display information related to content sharing as a popup.

The display 120 may display a popup corresponding to notification information transmitted from the other display device, and may display guide information to inform a user who uses the first display device as a popup.

The display 120 may also display electronic program guide (EPG) information,

The display 120 may be provided as, but is not limited to, a cathode ray tube (CRT), a digital light processing (DLP) panel, a plasma display panel, a liquid crystal display (LCD) panel, an electro luminescence (EL) panel, an electrophoretic display (EPD) panel, an electrochromic display (ECD) panel, a light emitting diode (LED) panel, or an organic light emitting diode (OLED) panel.

The speaker 130 may output sound corresponding to a control command of the first processor 150.

The speaker 130 may output sound included in the content information selected by a user.

The speaker 130 may also output input information corresponding to a user input as sound.

The speaker 130 may also output guidance for network selection and sharing settings as voice.

The speaker 130 may output a notification of a popup display related to content sharing as sound.

The first communication circuitry 140 may perform communication with the AP 4, and perform communication with the remaining display devices 100b, 100c, and 100d. Here, the remaining display devices 100b, 100c, and 100d may include display devices excluding the first display device 100a from among the plurality of display devices.

The first communication circuitry 140 may include a first receiver 141 that receives information transmitted from the AP 4 and at least one of the remaining display devices 100b, 100c, and 100d and delivers the received information to the first processor 150, and a first transmitter 142 that transmits information to the AP 4 and at least one of the remaining display devices 100b, 100c, and 100d in response to a control command of the first processor 150.

The first communication circuitry 140 may include one or more components enabling communication with an external device, and may include, for example, at least one of a short-range wireless communication module, a wired communication module, or a wireless communication module. Here, the external device may include the user device 2 and the server 3, and may further include a router.

The short-range wireless communication module may include various short-range wireless communication modules that transmit and receive signals using a wireless communication network at a short range, such as a Bluetooth module, an infrared communication module, an radio frequency identification (RFID) communication module, a wireless local access network (WLAN) communication module, an NFC communication module, a Zigbee communication module, etc.

The wired communication module may include various wired communication modules such as a local area network (LAN) module, a wide area network (WAN) module, or a value added network (VAN) module, as well as various cable communication modules such as universal serial bus (USB), high definition multimedia interface (HDMI), digital visual interface (DVI), recommended standard 232 (RS-232), power line communication, or plain old telephone service (POTS).

The wireless communication module may include, in addition to a Wi-fi module and a wireless broadband (Wibro) module, a wireless communication module that supports various wireless communication methods such as global system for mobile communication (GSM), code division multiple access (CDMA), wideband code division multiple access (WCDMA), universal mobile telecommunications system (UMTS), time division multiple access (TDMA), long term evolution (LTE).

The wireless communication module may further include an antenna that transmits and receives signals of the access point and the plurality of display devices, and a signal conversion module for modulating a digital control signal output from the first processor 150 into an analog radio signal and demodulating the received analog radio signal into a digital control signal.

The first communication circuitry 140 may vary depending on a communication method of the external device to be communicated with, the AP 4, and the plurality of display devices.

In a case where the first display device is a television or a projector, the first communication circuitry 140 may perform communication with a remote controller 5.

The first communication circuitry 140 for performing communication with the remote controller 5 may perform at least one of Bluetooth communication, Zigbee communication, RF communication, or infrared communication.

The remote controller 5 may receive a user input and transmit input information corresponding to the received user input to the first display device 100a.

The remote controller 5 may receive at least one of an on/off command, channel information, volume information, or character information of the first display device 100a.

The remote controller 5 may receive at least one of up/down/left/right movement information of a cursor, confirmation information, or cancellation information. Here, the character information may include numbers, English letters, Korean letters, and special characters.

The remote controller 5 may receive shortcut information for a predetermined website, a network selection command, a selection command for a display device to be shared, and may receive identification information of the display device, sharing setting information, and viewing proposal information.

The remote controller 5 may receive a viewing approval command, a viewing rejection command, a selection command for recorded content, a command to play recorded content, and an approval command (OK, Yes) and a rejection command (No) for popup information.

The remote controller 5 may include hardware devices, such as various types of buttons or switches, a pedal, a keyboard, a mouse, a track-ball, various levers, a handle, or a stick for receiving a user input.

In addition, the remote controller 5 may also include a software device, e.g., a GUI device such as a touch pad.

The first processor 150 controls overall operations related to the first display device 100a. One or two or more first processors 150 may be provided in the first display device 100a. That is, at least one first processor 150 may be provided.

The first processor 150 controls the operation of the first display device 100a using data stored in the first memory 151.

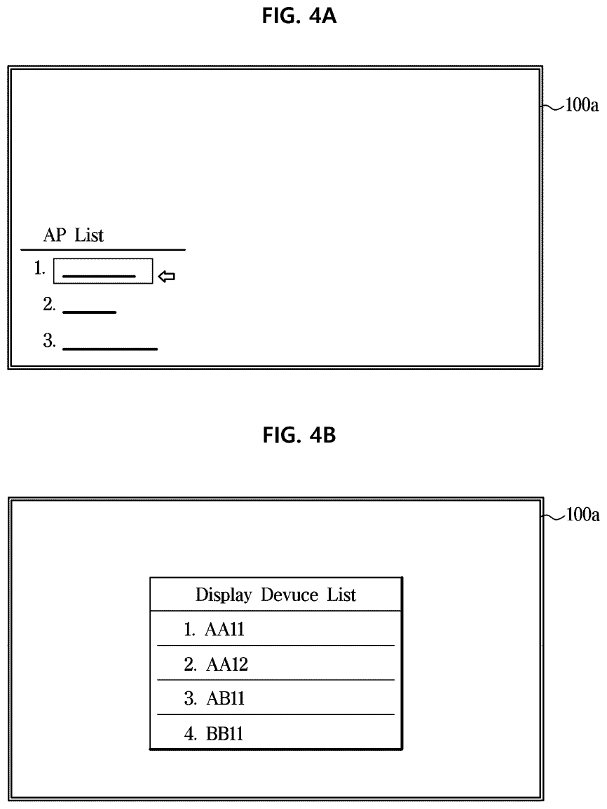

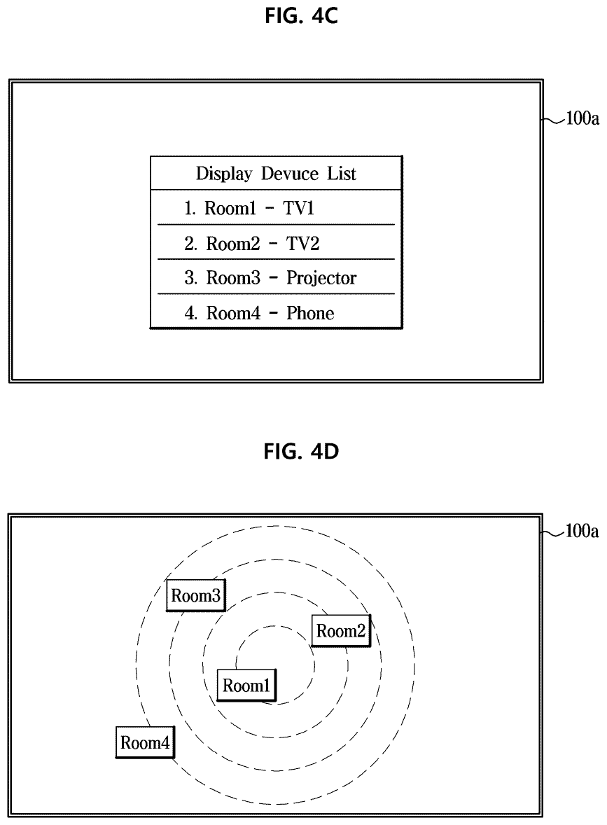

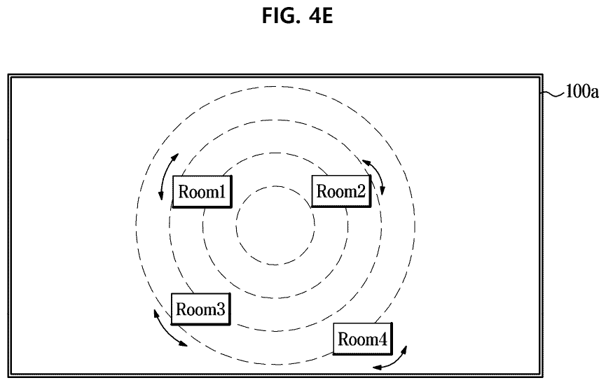

The operation of the first processor 150 is described in more detail. The operation of the first processor 150 is described with reference to FIG. 4A, FIG. 4B, FIG. 4C, FIG. 4D, and FIG. 4E to FIG. 11.

Based on receiving a selection command for the main mode through the input 110 or the remote controller 5, the first processor 150 may set the first display device as a main display device and set the second, third, and fourth display devices as sub display devices.

The first processor 150 may allow identification information of the display device in the main mode and identification information of the display devices in the sub mode to be stored in the first memory 151.

The first processor 150 may transmit the identification information of the display device in the main mode and the identification information of the display devices in the sub mode to the AP 4.

Based on receiving a selection command for the sub mode through the input 110 or the remote controller 5, the first processor 150 may set the first display device as a sub display device. In this case, the first processor 150 may receive identification information of a main display device and identification information of the remaining sub display devices from the AP 4.

As shown in FIG. 4A, based on receiving a network search command from the input 110 or the remote controller 5, the first processor 150 searches for a communicable network and controls the display 120 to display a list of the retrieved communicable networks.

The first processor 150 controls the first communication circuitry 140 to connect to the AP 4 based on network selection information received through the input 110 or the remote controller 5 from among the list of communicable networks.

The network information received through the input 110 may include identification information of the network, and may further include password information.

The first processor 150 may receive connection success information or connection failure information from the AP 4, and control the display 120 to display the received connection success information or connection failure information.

The operation of the first processor 150 in the main mode is described below.

The first processor 150 may receive identification information and received signal strength indicator (RSSI) information of a plurality of display devices from the AP 4.

The first processor 150 may also receive the identification information and distance information of the plurality of display devices from the AP 4.

The first processor 150 may also receive the identification information and ranking information of the received signal strengths of the plurality of display devices from the AP 4.

In a case where the identification information and the RSSI information of the plurality of display devices are received, the first processor 150 may recognize the distance information between the AP 4 and each of the first display devices based on the RSSI information of the first display devices, recognize the distance information between the AP 4 and each of the second display devices based on the RSSI information of the second display devices, recognize the distance information between the AP 4 and each of the third display devices based on the RSSI information of the third display devices, and recognize the distance information between the AP 4 and each of the fourth display devices based on the RSSI information of the fourth display devices.

The first processor 150 may match the recognized distance information of the first, second, third, and fourth display devices with the identification information of the first, second, third, and fourth display devices, and may allow the matched information to be stored in the first memory 151.

The first processor 150 may determine a display order based on the distance information from the AP 4. For example, the first processor 150 may control the display 120 to display the display device closest to the AP 4 as first rank, and the display device farthest from the AP 4 as fourth rank.

The first processor 150 may control the display 120 to display the identification information of the first, second, third, and fourth display devices based on the recognized distance information of the first, second, third, and fourth display devices.

As shown in FIG. 4B, in displaying the identification information of the first, second, third, and fourth display devices, the first processor 150 may control the display 120 to display model information of the first, second, third, and fourth display devices as the identification information of the first, second, third, and fourth display devices.

The first processor 150 may also determine a display order of the identification information of the plurality of display devices based on the RSSI information or the ranking information of the received signal strengths of the plurality of display devices.

For example, the first processor 150 may also recognize the ranking information of the received signal strengths of the first display device 100a, the second display device 100b, the third display device 100c, and the fourth display device 100d based on the RSSI information of the plurality of display devices, and determine the display order of the identification information of the plurality of display devices based on the recognized ranking information.

In this instance, the first processor 150 may determine a higher rank for a stronger received signal, and a lower rank for a weaker received signal.

That is, the first processor 150 may recognize a display device with the strongest received signal as the first-rank display device, a display device with the second strongest received signal as the second-rank display device, a display device with the third strongest received signal as the third-rank display device, and a display device with the weakest received signal as the fourth-rank display device.

The first processor 150 may receive space name information and device name information as the identification information of the first, second, third, and fourth display devices through the input 110 or the remote controller 5.

As shown in FIG. 4C, the first processor 150 may display the identification information of the first, second, third, and fourth display devices by changing the model information of the first, second, third, and fourth display devices to the received space name information and device name information of the first, second, third, and fourth display devices.

The first processor 150 may change the first-rank model information AA11 to Room1-TV1, change the second-rank model information AA12 to Room2-TV2, change the third-rank model information AB11 to Room3-Projector, and change the fourth-rank model information BB11 to Room4-Phone.

The first processor 150 may match the model information, the space name information, and the device name information of the first, second, third, and fourth display devices, and may control the first memory 251 to store the matched information.

The first processor 150 may also match the model information, the space name information, and the device name information of the first, second, third, and fourth display devices, and may transmit the matched information to the AP 4 or to the second, third, and fourth display devices.

The first processor 150 may control the display 120 to display a plurality of circular guide lines, and display the identification information of the first, second, third, and fourth display devices on each of the plurality of circular guide lines.

The number of the plurality of circular guide lines may correspond to the number of the plurality of display devices. For example, the plurality of circular guide lines may include a first circular guide line, a second circular guide line, a third circular guide line, and a fourth circular guide line.

The plurality of circular guide lines may have different diameters. In addition, location information of the center of the plurality of circular guide lines may include the location information of the access point.

A length of a diameter of each of the plurality of circular guide lines may be a length corresponding to the distance information of each of the first, second, third, and fourth display devices.

As shown in FIG. 4D, the first processor 150 may control the display 120 to display the identification information of the first, second, third, and fourth display devices on each of the plurality of circular guide lines based on the distance information of the first, second, third, and fourth display devices. In this instance, the first processor 150 may also control the display 120 to display only the space name information as the identification information of the first, second, third, and fourth display devices.

More specifically, the first processor 150 may identify a display device that is closest to the AP 4 and allow the identification information of the identified display device to be displayed on the circular guide line with the smallest diameter. The first processor 150 may identify a display device that is second closest to the AP 4 and allow the identification information of the identified display device to be displayed on the circular guide line with the second smallest diameter. The first processor 150 may identify a display device that is third closest to the AP 4 and allow the identification information of the identified display device to be displayed on the circular guide line with the third smallest diameter. The first processor 150 may identify a display device that is farthest from the AP 4 and allow the identification information of the identified display device to be displayed on the circular guide line with the largest diameter.

The first processor 150 may identify a fixed display device and a portable display device that is easy to move (e.g., mobile device) among the plurality of display devices based on the identification information of the plurality of display devices, and control the display to display the identification information of the mobile device among the plurality of display devices differently from the identification information of the remaining display devices.

For example, the first processor 150 may allow the identification information of the mobile device to be displayed in red font, and allow the identification information of the remaining display devices to be displayed in blue font.

The first processor 150 may also determine whether placement information of at least one display device has changed based on RSSI information of the at least one display device, and based on determining that the placement information of the at least one display device has changed, may control the display to display a popup notifying the change in the placement information of the at least one display device.

Based on receiving display position adjustment information of the identification information of the at least one display device through the input 110 or the remote controller 5, the first processor 150 may adjust a display position of the identification information of the at least one display device displayed on the at least one circular guide line, based on the received display position adjustment information of the identification information of the at least one display device.

To adjust the display position of the identification information of the at least one display device on the at least one circular guide line, the first processor 150 may adjust a display direction of the identification information of the at least one display device displayed on the at least one circular guide line.

To adjust the display position of the identification information of the at least one display device on the at least one circular guide line, the first processor 150 may also adjust the display position of the identification information of the at least one display device to another circular guide line, and adjust a display direction on the other circular guide line.

As shown in FIG. 4E, based on receiving display position adjustment information of the identification information (Room2) of the second display device through the input 110 or the remote controller 5, the first processor 150 may adjust a display position of the identification information (Room2) of the second display device on the third circular guide line based on the display position adjustment information of the identification information (Room2) of the second display device by adjusting a display direction of the identification information (Room2) of the second display device on the third circular guide line.

As shown in FIG. 4E, based on receiving display position adjustment information of the identification information (Room1) of the first display device through the input 110 or the remote controller 5, the first processor 150 may adjust a display position of the identification information (Room1) of the first display device on the second circular guide line to the first circular guide line based on the display position adjustment information of the identification information (Room1) of the first display device, and adjust a display direction of the identification information (Room1) of the first display device on the first circular guide line.

Based on the display position adjustment of the identification information of the at least one display device being completed, the first processor 150 may transmit display position information of the identification information of the plurality of display devices to the AP 4.

Based on the display position adjustment of the identification information of the at least one display device being completed, the first processor 150 may store the display position information of the identification information of the plurality of display devices, and transmit the display position information of the identification information of the plurality of display devices to the second, third, and fourth display devices.

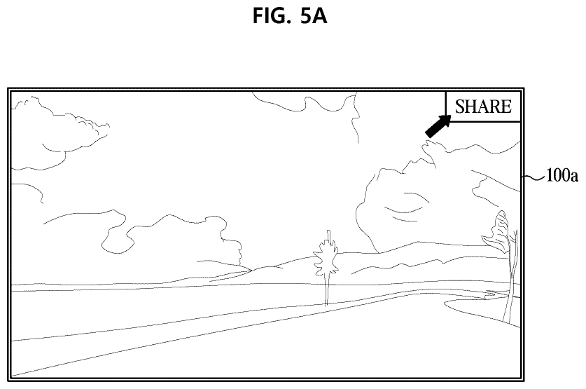

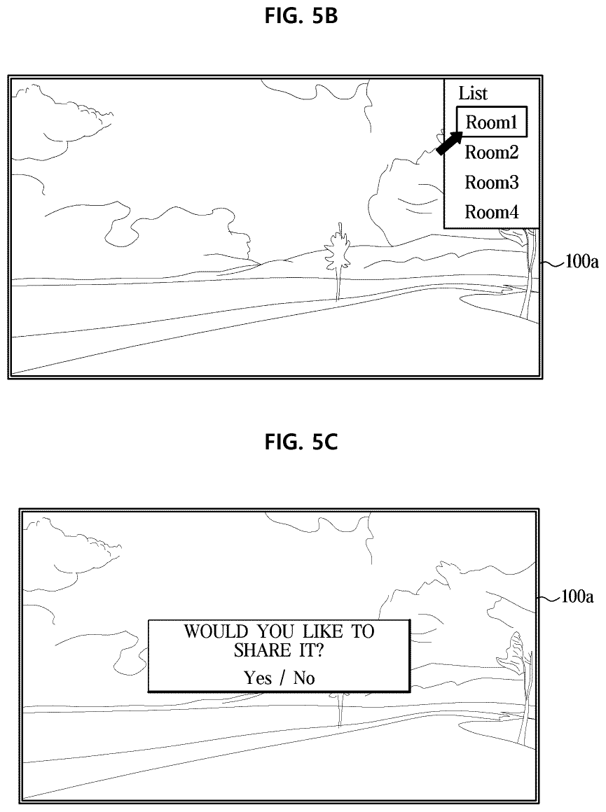

As shown in FIG. 5A, based on determining that a cursor moved according to a signal from the remote controller 5 is positioned at a corner of the display 120 of the first display device, the first processor 150 may determine that sharing setting information is received.

The first processor 150 may also determine whether the sharing setting information is received through the input 110 or the remote controller 5.

As shown in FIG. 5B, the first processor 150 controls the display 120 to display a list of the plurality of display devices connected, directly or indirectly, to the AP 4.

In a case where a single display device is selected from the list of display devices displayed on the display, the first processor 150 may transmit sharing proposal information to the selected display device.

As shown in FIG. 5C, the selected display device may display the sharing proposal information, and may transmit sharing rejection information or sharing approval information received through the input or the remote controller of the selected display device to the first display device.

When transmitting the sharing proposal information to at least one of the second display device 100b, the third display device 100c, or the fourth display device 100d, the first processor 150 may also transmit agreement terms information for a sharing service.

The first processor 150 may set a display device that transmits consent information as a shareable display device, and set a display device that does not transmit consent information as a non-shareable display device.

The first processor 150 may control the first memory 151 to store identification information of the shareable display device and identification information of the non-shareable display device.

Based on receiving viewing proposal information through the input 100 or the remote controller 5, the first processor 150 may display the identification information of the plurality of display device 100a, 100b, 100c, and 100d that may communicate through the AP 4.

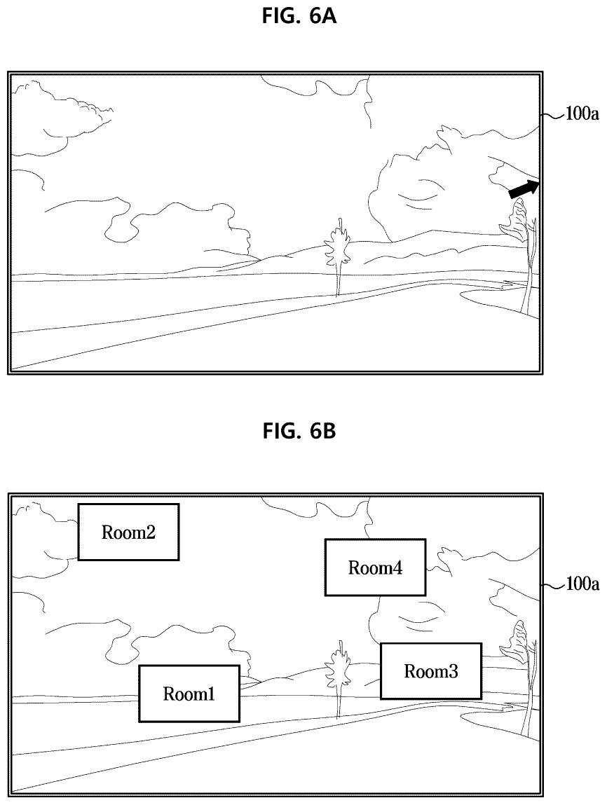

As shown in FIG. 6A, based on determining that a cursor moved according to a signal from the remote controller 5 is positioned at a corner of the display of the first display device, and that approval information is received from the remote controller 5, the first processor 150 may determine that the viewing proposal information is received.

The corner of the display of the first display device may be a preset corner from among a plurality of corners of the display.

As shown in FIG. 6B, the first processor 150 may display content information received through the input 110 or the remote controller 5 as a main image, and display the identification information of the second, third, and fourth display devices as sub images.

The sub image displaying the identification information of the second display device, the sub image displaying the identification information of the third display device, and the sub image displaying the identification information of the fourth display device may be thumbnail images of a predetermined shape.

For example, the predetermined shape may be a triangular shape, a quadrangular shape, a pentagonal shape, or a circular shape.

Each of the sub images displayed on the display 120 of the first display device may be smaller than the main image displayed on the first display device.

The first processor 150 may control the display 120 to display the sub image displaying the identification information of the second display device 100b, the sub image displaying the identification information of the third display device 100c, and the sub image displaying the identification information of the fourth display device 100d based on the display position information of the identification information of the second display device 100b, the third display device 100c, and the fourth display device 100d stored in the first memory 151.

The first processor 150 may control the display 120 to display the plurality of sub images without a plurality of circular guide lines.

The identification information of the display devices in the sub images displayed on the display 120 may include the space name information of the second, third, and fourth display devices.

The first processor 150 may confirm state information of the second display device 100b, the third display device 100c, and the fourth display device 100d, and change a display method of the plurality of sub images based on the confirmed state information of the second display device 100b, the third display device 100c, and the fourth display device 100d.

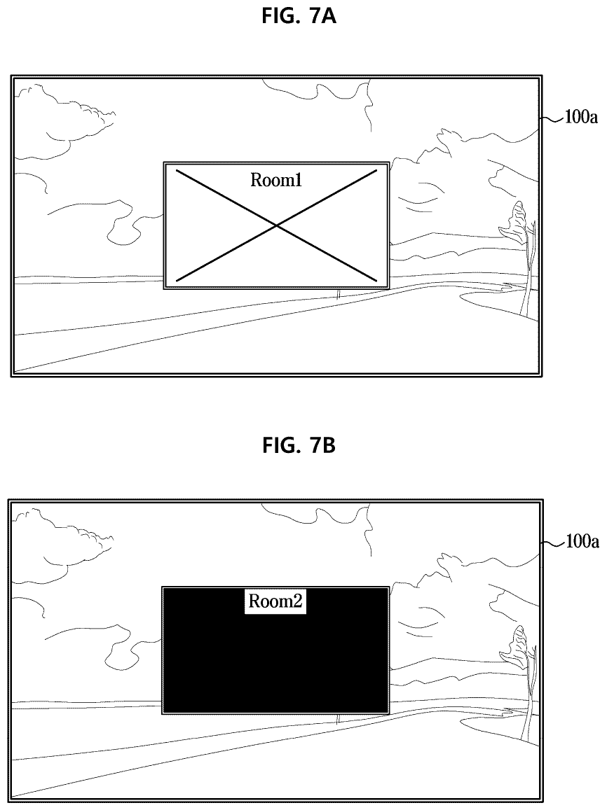

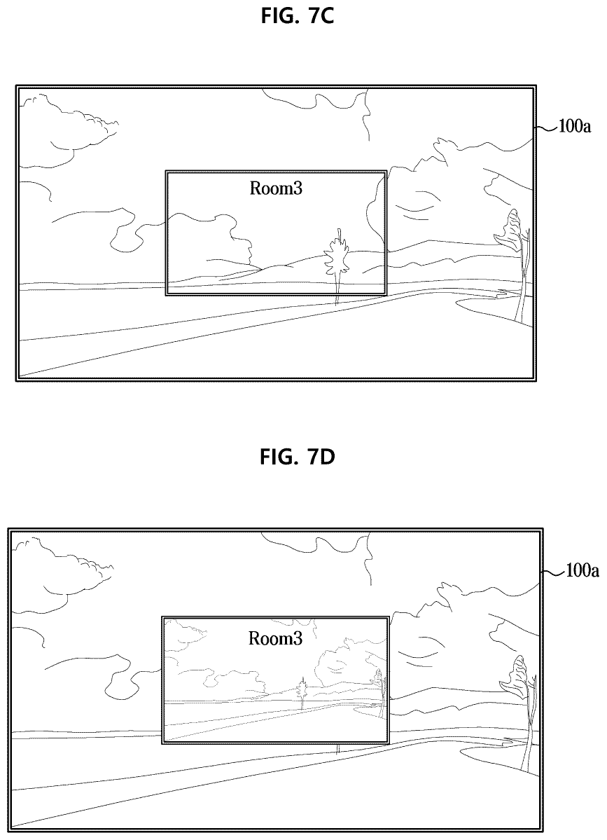

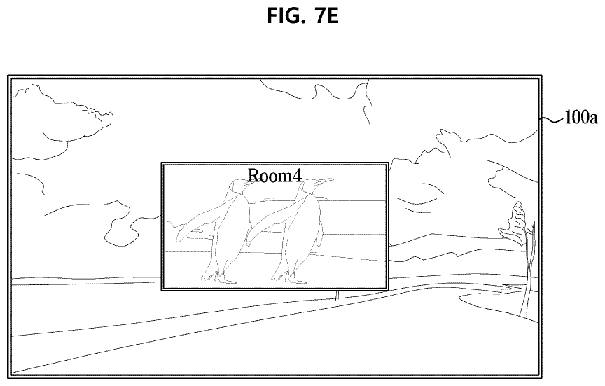

As shown in FIG. 7A, the first processor 150 may control the display 120 to display identification information of a non-shareable display device and marking information indicating that the display device is non-shareable on a sub image corresponding to the non-shareable display device.

For example, the marking information indicating that the display device is non-shareable may include X information.

As shown in FIG. 7B, the first processor 150 may confirm state information of shareable display devices, confirm a display device whose power is turned off among the shareable display devices, and confirm a sub image corresponding to the confirmed display device. In addition, the first processor 150 may control the display 120 to display identification information of the confirmed display device on the confirmed sub image, and display the sub image in a first color. For example, the first color may be black.

The first processor 150 may confirm the state information of shareable display devices, confirm a display device whose power is turned on among the shareable display devices, and confirm content information being output from the display device whose power is turned on.

In a case where the shareable display device with power on is the fourth display device 100d, the first display device 100a may request that the fourth display device 100d provide the content information being output from the fourth display device 100d. In this instance, the fourth display device 100d may capture the content information being output and transmit the captured image information to the first display device 100a.

The fourth display device 100d may also encode the content information being output for a preset time and transmit the encoded image information to the first display device 100a.

The first processor 150 confirms the content information being output from the fourth display device 100d, and controls the display 120 to display the confirmed content information on the sub image displaying the identification information of the fourth display device 100d.

The first processor 150 determines whether the content information being output from the fourth display device 100d is the same as the content information being output from the first display device 100a, and based on determining that the two contents are the same, adjusts a brightness or transparency of the sub image displaying the identification information and the content information of the fourth display device 100d.

As shown in FIG. 7C, the first processor 150 may adjust the sub image displaying the identification information and the content information of the fourth display device 100d to be transparent.

The first processor 150 may adjust the sub image displaying the identification information and the content information of the fourth display device 100d to be bright.

The first processor 150 may darken or adjust the sub image displaying the identification information and the content information of the fourth display device 100d to be opaque.

As shown in FIG. 7D, the first processor 150 may also control the display 120 to display the sub image displaying the identification information and the content information of the fourth display device 100d.

As shown in FIG. 7E, based on determining that the content information being output from the fourth display device 100d is different from the content information being output from the first display device 100a, the first processor 150 displays the sub image displaying the identification information and the content information of the fourth display device 100d. In this case, the brightness or transparency of the main image of the first display device 100a and the sub image corresponding to the fourth display device 100d may be the same.

Based on receiving content selection information through the input 110 or the remote controller 5, the first processor 150 controls the output of first content information based on the received content selection information.

Based on receiving viewing proposal information through the input 110 or the remote controller 5 during the output of the first content information, the first processor 150 may display a plurality of sub images corresponding to state information of the plurality of display devices, respectively.

Based on receiving viewing proposal information through the input 110 or the remote controller 5 during the output of the first content information, the first processor 150 may also display a list of a plurality of display devices connected through the AP 4.

Based on receiving selection information for a display device through the input 110 or the remote controller 5, the first processor 150 may transmit viewing proposal information to the selected display device.

The following description is made based on an assumption that the selected display device is the second display device.

When transmitting the viewing proposal information, the first processor 150 obtains first content information being output from the first display device 100a for a preset time, encodes the first content information obtained for the preset time, and transmits the encoded first content information to the second display device 200b along with the viewing proposal information.

The first processor 150 may transmit the encoded first content information to the second display device 100b along with electronic program guide (EPG) information.

After transmitting the viewing proposal information, the first processor 150 determines whether information about command reception is received from the second display device 100b. Based on determining that the information about command reception has not been received, the first processor 150 confirms an end time of the first content based on the EPG information, and records and stores the first content information until the confirmed end time.

Here, determining that the information about command reception has not been received may include determining that neither viewing approval information nor viewing rejection information is received through the input or the remote controller of the second display device 100b.

Based on determining that information about not receiving a command is received from the second display device 100b, the first processor 150 may also confirm the end time of the first content based on the EPG information, and record and store the first content information until the confirmed end time.

After transmitting the viewing proposal information, based on determining that rejection information is received from the second display device 100b, the first processor 150 may confirm the end time of the first content based on the EPG information, and record and store the first content information until the confirmed end time of the first content.

In a case where the current time is the end time of the first content, the first processor 150 may transmit the recorded and stored first content information to the second display device 100b.

After transmitting the viewing proposal information, based on determining that approval information is received from the second display device 100b, the first processor 150 may transmit the first content information to the second display device 100b.

After the recording of the first content information is completed and a signal for a user input is received from the second display device 100b, the first processor 150 may also transmit the recorded and stored first content information to the second display device 100b.

The operation of the first processor 150 in the sub mode is described below.

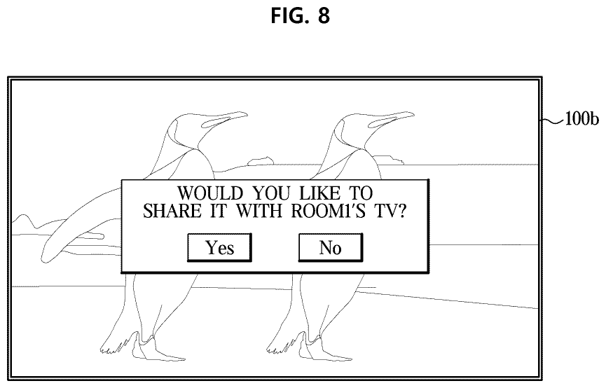

As shown in FIG. 8, based on receiving sharing proposal information from the main display device, the first processor 150 may control the display to display a popup for a sharing service with a main display device.

The first processor 150 may determine whether approval information for the sharing proposal is received through the input 110 or the remote controller 5. Based on determining that the approval information is received, the first processor 150 may transmit the approval information for the sharing proposal to the main display device. Based on determining that rejection information for the sharing proposal is received, the first processor 150 may transmit the rejection information for the sharing proposal to the main display device.

Based on determining that the approval information is received, the first processor 150 may control the display 120 to display agreement terms information for the sharing service. Based on determining that consent information is received through the input 110 or the remote controller 5, the first processor 150 may also transmit approval information for the sharing proposal to the main display device.

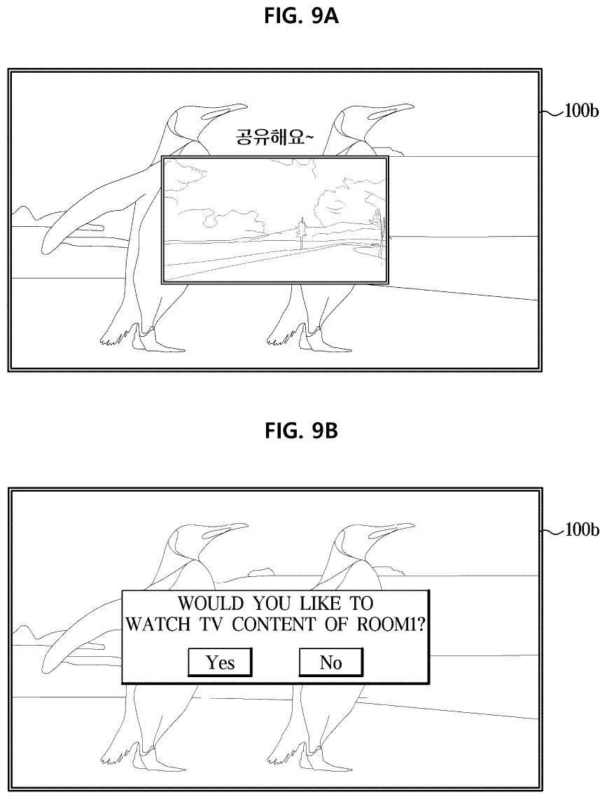

As shown in FIG. 9A, the first processor 150 may control the display 120 to display content information being output from the first display device as a main image and display decoded content information as a sub image that is superimposed on the main image.

Based on receiving a preview command through the input 110 or the remote controller 5, the first processor 150 may also decode the encoded content information and control the decoded content information to be displayed.

Receiving the preview command may include selection for a preview button within the popup displayed on the display 120 of the first display device,

As shown in FIG. 9B, based on receiving viewing proposal information from the main display device, the first processor 150 may display the received viewing proposal information as a popup.

When displaying the viewing proposal information of the main display device, the first processor 150 may control the display 120 to display the viewing proposal information together with identification information of the recorded content, such as program name, channel name, cast, etc., based on the EPG information received from the main display device.

The first processor 150 determines whether a command is received within a reference time from the time of receiving the viewing proposal information through the input 110 or the remote controller 5. Based on determining that the command has not been received, the first processor 150 terminates the output of the decoded content information and continuously outputs the content information being output from the first display device.

The first processor 150 may confirm the command received through the input 100 or the remote controller 5, and based on determining that the confirmed command is a viewing rejection command, may transmit viewing rejection information to the main display device.

Based on determining that the confirmed command is the viewing rejection command, the first processor 150 may also record the content information received from the main display device. In this case, the first processor 150 may confirm an end time of the content based on the EPG information, and record the content information received from the main display device until the confirmed end time.

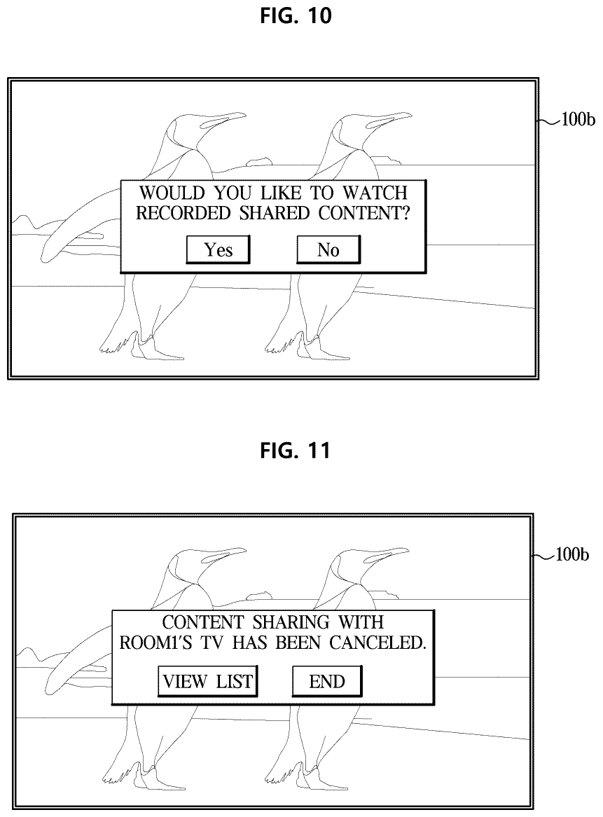

As shown in FIG. 10, based on the recording of the content information received from the main display device being completed, the first processor 150 may control the display to display a popup to ask whether to view the recorded content information.

Receiving the viewing rejection command through the input of the first display device may include selection for a rejection button within the popup.

Based on determining that the command received through the input 110 or the remote controller 5 is a viewing approval command, the first processor 150 may transmit approval information to the main display device.

Based on receiving content information from the main display device, the first processor 150 may terminate the content information being output from the first display device and control the content information received from the main display device to be displayed.

Receiving the viewing approval command through the input may include selection for an approval button within the popup.

As shown in FIG. 11, based on the recording of the content information transmitted from the main display device being completed, the first processor 150 may determine whether a user input is received, and based on determining that the user input is received, may control the display 120 to display a popup notifying that content sharing and viewing is canceled due to a popup that was not checked.

The first processor 150 may control the display 120 to display a list of recorded content in association with the unchecked popup.

That is, based on receiving the user input, the first processor 150 may display the viewing proposal information of the first display device that was canceled due to the unchecked popup about the viewing proposal information.

Based on receiving a command to view the list of recorded content within the popup, the first processor 150 may display the list of recorded content, and in a case where one content is selected through the input 110, may control the display 120 to display the selected content information.

In a case where one content is selected and a playback command is received through the input 110, the first processor 150 may control the display 120 to display the selected content information.

Based on receiving an end command through the input 110, the first processor 150 may terminate the display of the popup displayed on the display 120.

In a case where one content is selected and a deletion command is received through the input or the remote controller, the first processor 150 may delete the selected content information. That is, the first processor 150 may delete the content information stored in the first memory 151.

The first memory 151 may store identification information and network information of the AP 4.

The first memory 151 may store identification information of a plurality of display devices connected to the AP 4 and identification information of at least one home appliance 10.

The first memory 151 may store the identification information of a plurality of display devices.

The identification information of s display device may include space name information and name information of the display device.

The identification information of s display device may include model name information of the display device.

The first memory 151 may store RSSI information of a plurality of display devices. Here, the RSSI information of each of the plurality of display devices may be RSSI information received by the access point.

The first memory 151 may store distance information of a plurality of display devices. Here, the distance information of each of the plurality of display devices may be distance information from the access point.

The first memory 151 may store information about a distance corresponding to a received signal strength as a table.

The first memory 151 may store shareable information and non-shareable information set for each display device.

The first memory 151 may store recorded content information.

The first memory 151 stores data for an algorithm for controlling the operations of the components of the first display device 100a or data for a program embodying the algorithm.

The first memory 151 may be implemented as at least one of a non-volatile memory element, such as cache, read only memory (ROM), programmable ROM (PROM), erasable programmable ROM (EPROM), electrically erasable programmable ROM (EEPROM), and flash memory, or a volatile memory element, such as random access memory (RAM), or a storage medium such as a hard disk drive (HDD), CD-ROM, but is not limited thereto.

The first memory 151 and the first processor 150 may each be implemented as separate chips. Alternatively, the first memory 151 and the first processor 150 may be implemented as a single chip.

At least one component may be added or omitted corresponding to the performance of the components of the display device shown in FIG. 3. In addition, it will be easily understood by those skilled in the art that mutual positions of the components may be modified corresponding to the performance or structure of the display device.

Meanwhile, each component shown in FIG. 3 refers to a software and/or hardware component such as a field programmable gate array (FPGA) and an application specific integrated circuit (ASIC).

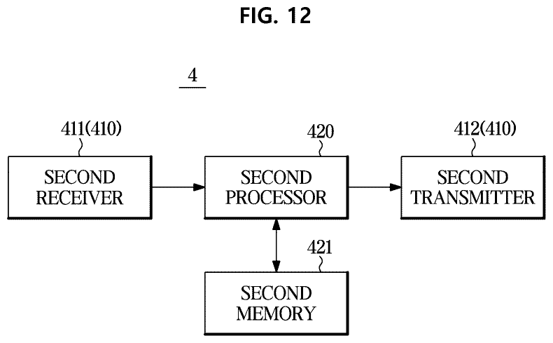

FIG. 12 is a control block diagram of an access point provided in a display system according to an embodiment.

The access point (AP, 4) includes second communication circuitry 410, a second processor 420, and a second memory 421.

The second communication circuitry 410 may connect the home appliance 10, the user device 2, and at least one display device to a wide area network (WAN) to which the server 3 is connected.

The second communication circuitry 410 may connect at least one home appliance 10 and a plurality of display devices to a local area network (LAN). Here, the local area network may be a home network.

The second communication circuitry 410 may communicate with the at least one home appliance 10 and the plurality of display devices using wireless communication such as Wi-Fi™ (IEEE 802.11), Bluetooth™ (IEEE 802.15.1), Zigbee (IEEE 802.15.4), and may connect to the wide area network (WAN) using wired communication, but is not limited thereto.

The second communication circuitry 410 may include a second receiver 411 that receives information transmitted from at least one of the plurality of display device 100a, 100b, 100c, and 100d and delivers the received information to the second processor 420, and a second transmitter 412 that transmits information to at least one of the plurality of display device 100a, 100b, 100c, and 100d in response to a control command of the second processor 420.

The second receiver 411 may confirm a power value of a received radio signal and transmit the confirmed power value to the second processor 420. Here, the power value of the radio signal may represent a strength of the received radio signal.

The second receiver 411 may transmit received signal strength indicator (RSSI) information to the second processor 420.

The second receiver 411 may transmit the RSSI information for each of the plurality of display devices to the second processor 420.

The second receiver 411 may also recognize at least one of a received radio signal level or quality. That is, the second receiver 411 may recognize at least one of reference signals received power (RSRP) or reference signals received quality (RSRQ).

The second communication circuitry 410 may further include an antenna that transmits and receives signals of the access point and the plurality of display devices, and a signal conversion module, comprising circuitry, for modulating a digital control signal output from the second processor 420 into an analog radio signal and demodulating the analog radio signal received through the antenna into a digital control signal.

The second processor 420 controls overall operations related to the AP 4. One or two or more second processors 420 may be provided in the AP 4. That is, at least one second processor 420 may be provided.

The second processor 420 controls the operation of the AP 4 using data stored in the second memory 421.

The second processor 420 may search for a plurality of display devices located within a preset distance.

The second processor 420 may confirm identification information and RSSI information of the retrieved display devices. That is, the second processor 420 may confirm the RSSI information and the identification information of the plurality of display devices transmitted from the second receiver 411.

The identification information of the retrieved display devices may include model information of the plurality of display devices.

Based on receiving space name information and device name information of the plurality of display devices from the first display device, the second processor 420 may match the model information of the plurality of display devices with the space name information and the device name information, and allow the matched information to be stored. In this case, the space name information and the device name information of the plurality of display devices may be the identification information of the plurality of display devices.

The second processor 420 may match the space name information and the device name information corresponding to the model information of the display device, and allow the matched information to be stored in the second memory 421.

The second processor 420 may match the identification information with the RSSI information for each of the plurality of display devices and allow the matched information to be stored in the second memory 421.

The second processor 420 may transmit the matched identification information and RSSI information of the plurality of display devices to the plurality of display devices.

The second processor 420 may also transmit the matched identification information and RSSI information of the plurality of display devices to a main display device among the plurality of display devices.

In a case where a network password is set, based on receiving password information of the network from at least one display device, the second processor 420 may determine whether the received password information matches preset password information. Based on determining that the received password information matches the preset password information, the second processor 420 may grant communication authority to the at least one display device, and based on determining that the received password information does not match the preset password information, may restrict communication authority to the at least one display device.

Based on determining that the received password information matches the preset password information, the second processor 420 may set the at least one display device as a display device for a home network.

The second processor 420 may compare currently received RSSI information of the at least one display device with pre-stored RSSI information of the at least one display device. Based on determining that the currently received RSSI information and the pre-stored RSSI information are different, the second processor 420 may transmit placement change information of the at least one display device corresponding to the change in the RSSI information of the at least one display device to the main display device.

The second processor 420 may determine whether a difference between the currently received signal strength and the pre-stored received signal strength is outside a preset range. Based on determining that the difference between the currently received signal strength and the pre-stored received signal strength is outside the preset range, the second processor 420 may determine that the currently received RSSI information and the pre-stored RSSI information are different.

In a case where it is determined that the placement of the at least one display device has changed, and it is determined that the at least one display device is a fixed display device based on the identification information of the at least one display device, the second processor 420 may also transmit the placement change information of the at least one display device to the main display device.

The second processor 420 may control the second communication circuitry 410 to transmit and receive information between the plurality of display devices.

The second memory 421 may store identification information, preset password information, and network information of the AP 4.

The second memory 421 may store identification information of a plurality of display devices connected to the AP 4.

The second memory 421 may store the matched identification information and RSSI information of the plurality of display devices.

The identification information and the RSSI information of the plurality of display devices stored in the second memory 421 may be updated in response to a placement change of at least one display device.

The second memory 421 stores data for an algorithm for controlling the operations of the components of the AP 4 or data for a program embodying the algorithm.

The second memory 421 may be implemented at least one of a non-volatile memory element, such as cache, read only memory (ROM), programmable ROM (PROM), erasable programmable ROM (EPROM), electrically erasable programmable ROM (EEPROM), and flash memory, or a volatile memory element, such as random access memory (RAM), or a storage medium such as a hard disk drive (HDD), CD-ROM, but is not limited thereto.

The second memory 421 and the second processor 420 may each be implemented as separate chips. Alternatively, the second memory 421 and the second processor 420 may be implemented as a single chip.

At least one component may be added or omitted corresponding to the performance of the components of the access point shown in FIG. 12. In addition, it will be easily understood by those skilled in the art that mutual positions of the components may be modified corresponding to the performance or structure of the access point.

Meanwhile, each component shown in FIG. 12 refers to a software and/or hardware component such as a field programmable gate array (FPGA) and an application specific integrated circuit (ASIC).

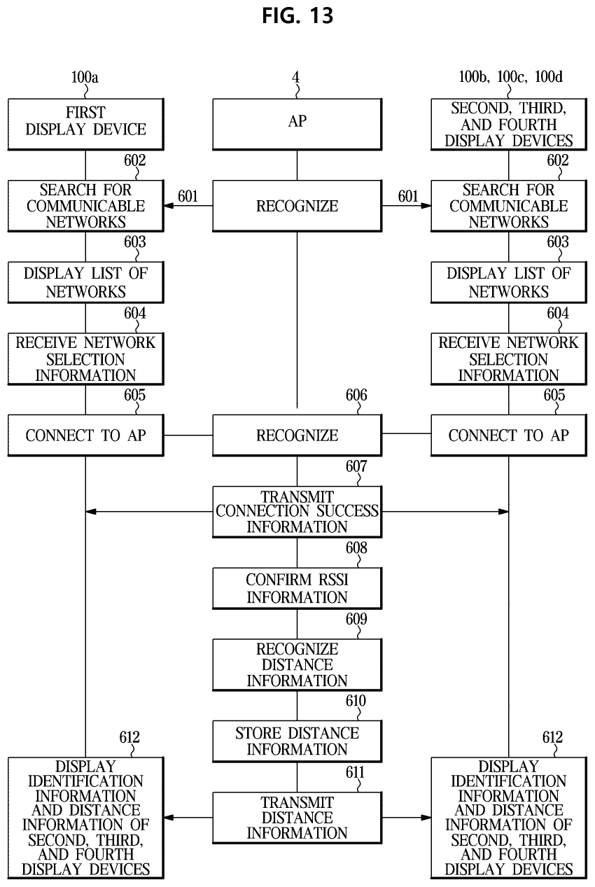

FIG. 13 is a control flowchart of displaying a list of display devices of a display system according to an embodiment.

The AP 4 may transmit a signal for communicating with the plurality of display device 100a, 100b, 100c, and 100d (601).

The first display device 100a searches for communicable networks (602) and displays a list of the retrieved communicable networks (603).

The first display device 100a connects to the AP 4 based on network selection information received by the input 110 from among the list of communicable networks (604),

The network information received by the input 110 may include identification information of the network, and may further include password information,

The first display device 100a may also receive network selection information from the remote controller 5.

The second display device 100b, the third display device 100c, and the fourth display device 100d may also connect to the AP 4 in the same manner as the first display device 100a.

The AP 4 may recognize the first display device 100a, the second display device 100b, the third display device 100c, and the fourth display device 100d connected via the network (606).

Based on determining that the first display device 100a, the second display device 100b, the third display device 100c, and the fourth display device 100d are successfully recognized, the AP 4 may transmit connection success information to the first display device 100a, the second display device 100b, the third display device 100c, and the fourth display device 100d (607).

The AP 4 may confirm identification information and RSSI information of the recognized first display device 100a, second display device 100b, third display device 100c, and fourth display device 100d (608).

The AP 4 may recognize distance information between the AP 4 and each of the first display devices based on the RSSI information of the first display devices, recognize distance information between the AP 4 and each of the second display devices based on the RSSI information of the second display devices, recognize distance information between the AP 4 and each of the third display devices based on the RSSI information of the third display devices, and recognize distance information between the AP 4 and each of the fourth display devices based on the RSSI information of the fourth display devices (609).

The AP 4 may match the recognized distance information of the first, second, third, and fourth display devices with the identification information of the first, second, third, and fourth display devices, and may allow the matched information to be stored in the second memory (610).

The AP 4 may transmit the recognized distance information and identification information of the first, second, third, and fourth display devices to the first, second, third, and fourth display devices (611).

In this case, each of the first, second, third, and fourth display devices may receive the identification information and the distance information of the first, second, third, and fourth display devices and store the received identification information and distance information of the first, second, third, and fourth display devices.

Each of the first, second, third, and fourth display devices may display the identification information and the distance information of the first, second, third, and fourth display devices (612).

The AP 4 may also transmit the confirmed identification information and RSSI information of the first display device 100a, the second display device 100b, the third display device 100c, and the fourth display device 100d to the first, second, third, and fourth display devices.

The AP 4 may also determine ranking information of the received signal strengths of the first display device 100a, the second display device 100b, the third display device 100c, and the fourth display device 100d based on the confirmed RSSI information of the first display device 100a, the second display device 100b, the third display device 100c, and the fourth display device 100d.

The AP 4 may determine a higher rank for a stronger received signal, and a lower rank for a weaker received signal.

That is, the AP 4 may determine a display device with the strongest received signal as the first-rank display device, a display device with the second strongest received signal as the second-rank display device, a display device with the third strongest received signal as the third-rank display device, and a display device with the weakest received signal as the fourth-rank display device.

The AP 4 may also transmit the ranking information of the received signal strengths of the plurality of display devices to the plurality of display devices.

In a case where setting information of a main display device is received from one of the plurality of display devices, the AP 4 may set the one display device as the main display device, and set the remaining display devices as sub display devices based on the received setting information of the main display device.

For example, in a case where setting information of a main display device that sets the second display device as main is received from the first display device, the AP 4 may set the second display device as the main display device and set the first, third, and fourth display devices as sub display devices based on the received setting information.

As another example, in a case where setting information of a main display device that sets the first display device as main is received from the first display device, the AP 4 may set the first display device as the main display device and set the second, third, and fourth display devices as sub display devices based on the received setting information.

The AP 4 may also transmit the identification information and the RSSI information of the first, second, third, and fourth display devices to the main display devices.

The AP 4 may also transmit the ranking information of the plurality of display devices to the main display device.

The AP 4 may also transmit the recognized distance information and identification information of the first, second, third, and fourth display devices to the main display devices.

Each of the plurality of display devices may receive at least one of the RSSI information, the ranking information of the received signal strengths, or the distance information of the first, second, third, and fourth display devices from the AP 4.

For example, each of the plurality of display devices may receive the identification information and the RSSI information of the first display device 100a, the second display device 100b, the third display device 100c, and the fourth display device 100d from the AP 4, and may display the identification information of the first, second, third, and fourth display devices based on the received RSSI information of the first, second, third, and fourth display devices.

Each of the plurality of display devices may display the identification information of the first, second, third, and fourth display devices in order from strongest to weakest received signal. For example, each of the plurality of display devices may display a display device with the strongest received signal as first rank, and a display device with the weakest received signal as fourth rank in the list of display devices.

In a case where the main display device is set, the main display device may receive the identification information and the RSSI information of the first, second, third, and fourth display devices from the AP 4, and display the identification information of the first, second, third, and fourth display devices based on the received RSSI information of the first, second, third, and fourth display devices.

As another example, each of the plurality of display devices may receive the identification information and the distance information of the first display device 100a, the second display device 100b, the third display device 100c, and the fourth display device 100d from the AP 4, and display the identification information of the first, second, third, and fourth display devices based on the received distance information of the first, second, third, and fourth display devices.

In a case where the main display device is set, the main display device may receive the identification information and the distance information of the first, second, third, and fourth display devices from the AP 4, and display the identification information of the first, second, third, and fourth display devices based on the received distance information of the first, second, third, and fourth display devices.

Hereinafter, an example where the first display device among the plurality of display devices is set as the main display device is described.

The first display device may receive at least one of the RSSI information, the ranking information of the received signal strengths, or the distance information of the first, second, third, and fourth display devices from the AP 4.

For example, the first display device may display the identification information of the first, second, third, and fourth display devices in order from strongest to weakest received signal. In this case, the first display device may display model information of the first, second, third, and fourth display devices as the identification information of the first, second, third, and fourth display devices.

The first display device may also determine the rank of the first, second, third, and fourth display devices based on the confirmed RSSI information of the first, second, third, and fourth display devices.

The first display device may determine a higher rank for a stronger received signal, and a lower rank for a weaker received signal.

That is, the first display device may determine a display device with the strongest received signal as the first-rank display device, a display device with the second strongest received signal as the second-rank display device, a display device with the third strongest received signal as the third-rank display device, and a display device with the weakest received signal as the fourth-rank display device.

The first display device may also transmit the ranking information of the first, second, third, and fourth display devices to all of the first, second, third, and fourth display devices.

The first display device may also store the ranking information of the first, second, third, and fourth display devices.

The first display device may recognize the distance information between the AP 4 and the first display device based on the RSSI information of the first display devices, recognize the distance information between the AP 4 and the second display device based on the RSSI information of the second display device, recognize the distance information between the AP 4 and the third display device based on the RSSI information of the third display device, and recognize the distance information between the AP 4 and the fourth display device based on the RSSI information of the fourth display device.

The first display device may display the identification information of the first, second, third, and fourth display devices based on the recognized distance information of the first, second, third, and fourth display devices.

The first display device may display the identification information of the first, second, third, and fourth display devices in order from closest to farthest distance. In this case, the first display device may display the model information of the first, second, third, and fourth display devices as the identification information of the first, second, third, and fourth display devices.

As another example, the first display device may also receive the identification information and the distance information of the first, second, third, and fourth display devices from the AP 4. In this case, the first display device may display the identification information of the first, second, third, and fourth display devices based on the received distance information of the first, second, third, and fourth display devices.

The first display device may receive space name information and device name information as the identification information of the first, second, third, and fourth display devices through the input 110.

The first display device may display the identification information of the first, second, third, and fourth display devices by changing the model information of the first, second, third, and fourth display devices to the received space name information and device name information of the first, second, third, and fourth display devices.

The first display device may match the model information, the space name information, and the device name information of the first, second, third, and fourth display devices, and may allow the matched information to be stored in the first memory 251.

The first display device may also match the model information, the space name information, and the device name information of the first, second, third, and fourth display devices, and transmit the matched information to the AP 4 or to the second, third, and fourth display devices.

The first display device may display a plurality of circular guide lines, and display the identification information of the first, second, third, and fourth display devices on each of the plurality of circular guide lines.

The number of the plurality of circular guide lines may correspond to the number of the plurality of display devices. For example, the plurality of circular guide lines may include a first circular guide line, a second circular guide line, a third circular guide line, and a fourth circular guide line.

The plurality of circular guide lines may have different diameters. In addition, location information of the center of the plurality of circular guide lines may include the location information of the access point.

The first display device may display the identification information of the first, second, third, and fourth display devices on each of the plurality of circular guide lines based on the distance information of the first, second, third, and fourth display devices.

More specifically, the first display device may identify a display device that is closest to the AP 4 and allow the identification information of the identified display device to be displayed on the circular guide line with the smallest diameter. The first display device may identify a display device that is second closest to the AP 4 and allow the identification information of the identified display device to be displayed on the circular guide line with the second smallest diameter. The first display device may identify a display device that is third closest to the AP 4 and allow the identification information of the identified display device to be displayed on the circular guide line with the third smallest diameter. The first display device may identify a display device that is farthest from the AP 4 and allow the identification information of the identified display device to be displayed on the circular guide line with the largest diameter.

The first display device may receive display position adjustment information of identification information of at least one display device through the input 110 or the remote controller 5, and may adjust a display position of the identification information of the at least one display device displayed on the at least one circular guide line based on the received display position adjustment information of the identification information of the at least one display device.

To adjust the display position of the identification information of the at least one display device on at least one guide line, the first display device may adjust a display direction of the identification information of the at least one display device on the at least one circular guide line.

To adjust the display position of the identification information of the at least one display device on the at least one circular guide line, the first display device may also adjust the display position of the identification information of the at least one display device to another circular guide line, and adjust a display direction on the other circular guide line.

For example, based on receiving display position adjustment information of the identification information of the second display device through the input 110 or the remote controller 5, the first display device may adjust a display position of the identification information of the second display device on the third circular guide line based on the display position adjustment information of the identification information of the second display device by adjusting a display direction of the identification information of the second display device on the third circular guide line.

Based on receiving display position adjustment information of the identification information of the first display device through the input 110 or the remote controller 5, the first display device may adjust a display position of the identification information of the first display device on the second circular guide line to the first circular guide line based on the display position adjustment information of the identification information of the first display device, and adjust a display direction of the identification information of the first display device on the first circular guide line.

Based on the display position adjustment of the identification information of the at least one display device being completed, the first display device may transmit display position information of the identification information of the plurality of display devices to the AP 4.

Based on the display position adjustment of the identification information of the at least one display device being completed, the first display device may store the display position information of the identification information of the plurality of display devices, and transmit the display position information of the identification information of the plurality of display devices to the second, third, and fourth display devices.

According to the embodiment, by displaying the identification information and the location information of communicable display devices within the home, a user may easily select a display device to be shared. In other words, the user may intuitively recognize the display device to be shared.

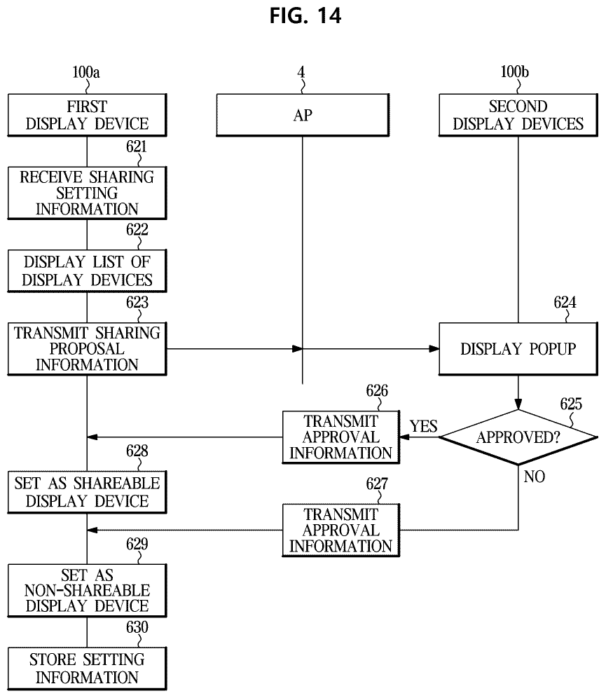

FIG. 14 is a control flowchart illustrating sharing settings of display devices of a display system according to an embodiment.

An example where a first display device of a plurality of display devices is set as a main display device is described.

Based on receiving sharing setting information through the input 110 or the remote controller 5 (621), the first display device displays a list of a plurality of display devices connected to the AP 4 (622).

The first display device transmits sharing proposal information to the second, third, and fourth display devices through the AP 4 (623).

When transmitting the sharing proposal information to the second display device 100b, the third display device 100c, and the fourth display device 100d, the first display device 100a may also transmit agreement terms information for a sharing service to the second display device 100b, the third display device 100c, and the fourth display device 100d.

Based on receiving the sharing proposal information of the first display device through the AP 4, the second display device 100b may display the sharing proposal information as a popup (624).

The second display device determines whether approval information for the sharing proposal is received through the input or the remote controller (625).

Based on determining that the approval information is received, the second display device may transmit the approval information for the sharing proposal to the first display device 100a (626), and based on determining that rejection information for the sharing proposal is received through the input or the remote controller of the second display device, the second display device may transmit the rejection information for the sharing proposal to the first display device 100a (627).

Based on determining that approval information is received, the second display device may display the agreement terms information for the sharing service, and based on receiving consent information through the input or the remote controller of the second display device, the second display device may also transmit the approval information for the sharing proposal to the first display device 100a.

Similar to the second display device, the third display device 100c and the fourth display device 100d may also transmit approval information or rejection information for the sharing proposal of the first display device to the first display device 100a.

The first display device 100a may set the display device that transmits the approval information for the sharing proposal as a shareable display device (628), and set the display device that transmits the rejection information for the sharing proposal as a non-shareable display device (629).

The first display device 100a may store identification information of the shareable display device and identification information of the non-shareable display device (630).

The first display device 100a may display state information of a plurality of display devices communicable through the AP 4, which is described in more detail below.

Based on receiving viewing proposal information through the input 110 or the remote controller 5, the first display device 100a may display the identification information of the plurality of display device 100a, 100b, 100c, and 100d that may communicate through the AP 4.

Based on determining that a cursor moved according to a signal from the remote controller 5 is positioned at a corner of the display of the first display device, and that approval information is received from the remote controller 5, the first display device 100a may determine that the viewing proposal information is received.

The first display device may display content information received through the input 110 or the remote controller 5 as a main image, and display the identification information of the second, third, and fourth display devices as sub images.

The sub image displaying the identification information of the second display device, the sub image displaying the identification information of the third display device, and the sub image displaying the identification information of the fourth display device may be thumbnail images of a predetermined shape.

For example, the predetermined shape may be a triangular shape, a quadrangular shape, a pentagonal shape, or a circular shape.

Each of the sub images displayed on the first display device may be smaller than the main image displayed on the first display device.

The first display device 100a may display the sub image displaying the identification information of the second display device 100b, the sub image displaying the identification information of the third display device 100c, and the sub image displaying the identification information of the fourth display device 100d based on the display position information of the identification information of the second display device 100b, the third display device 100c, and the fourth display device 100d stored in the first display device.

The first display device 100b may display the plurality of sub images without a plurality of circular guide lines.

The identification information of the second, third, and fourth display devices displayed in each sub image may include space name information of the second, third, and fourth display devices.

When displaying the plurality of sub images on the main image, the first display device 100b confirms whether the second display device 100b, the third display device 100c, and the fourth display device 100d are shareable or non-shareable display devices based on the sharing setting information, and displays marking information indicating that the display device is non-shareable on the sub image that displays the identification information of the non-shareable display device.

For example, the marking information indicating that the display device is non-shareable may include X information.

The non-shareable display device may be a display device that has not agreed to the agreement terms for the sharing service.

The first display device 100a may confirm state information of shareable display devices, confirm a display device whose power is turned off among the shareable display devices, and may display a sub image that displays the identification information of the display device whose power is turned off in a first color. For example, the first color may be black.

The first display device 100a confirms the state information of shareable display devices, confirms a display device whose power is turned on among the shareable display devices, and confirms content information being output from the display device with power on.

In a case where the shareable display device with power on is the fourth display device 100d, the first display device 100a may request that the fourth display device 100d provide the content information being output from the fourth display device 100d. In this instance, the fourth display device 100d may capture the content information being output and transmit the captured image information to the first display device 100a.

The fourth display device 100d may also encode the content information being output for a preset time and transmit the encoded image information to the first display device 100a.

The first display device 100a confirms the content information being output from the fourth display device 100d, and displays the confirmed content information on the sub image displaying the identification information of the fourth display device 100d.

The first display device 100a determines whether the content information being output from the fourth display device 100d is the same as the content information being output from the first display device 100a, and based on determining that the two contents are the same, adjusts a brightness or transparency of the sub image displaying the identification information and the content information of the fourth display device 100d.

For example, the first display device 100a may darken or adjust the sub image corresponding to the fourth display device 100d to be opaque.

As another example, the first display device 100a may brighten or adjust the sub image corresponding to the fourth display device 100d to be transparent.

Based on determining that the content information being output from the fourth display device 100d is different from the content information being output from the first display device 100a, the first display device 100a displays the sub image displaying the identification information and the content information of the fourth display device 100d. In this case, the brightness or transparency of the main image of the first display device 100a and the sub image corresponding to the fourth display device 100d may be the same.

Based on determining that the content information being output from the fourth display device 100d is different from the content information being output from the first display device 100a, the first display device 100a receives the identification information and the content information of the fourth display device 100d, and displays the received identification information and content information of the fourth display device 100d as a sub image, thereby preventing or reducing chances of a first user using the first display device from disturbing the content viewing of a second user using the fourth display device.

For example, in a case where the first user checks the sub image corresponding to the fourth display device on the first display device, and determines that the second user is watching an educational broadcast on the fourth display device, the first user does not propose viewing the content output through the first display device. Accordingly, the second user may avoid being disturbed by the sharing service in advance.

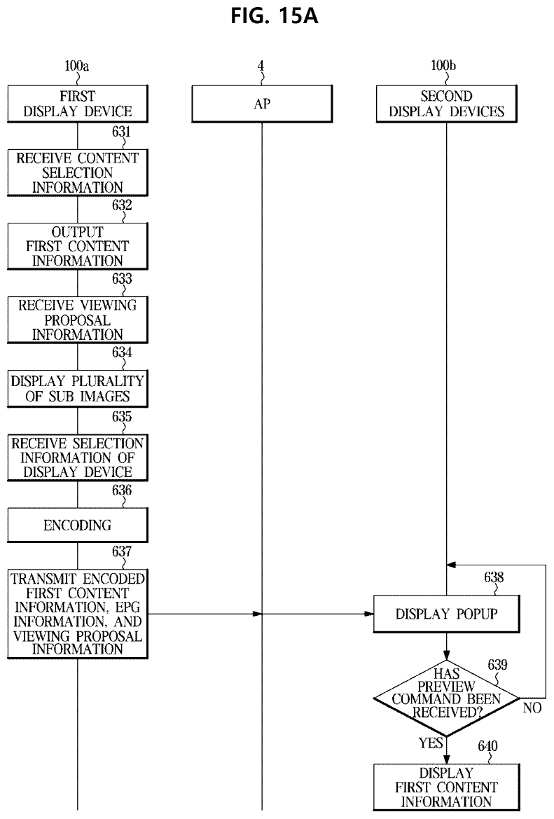

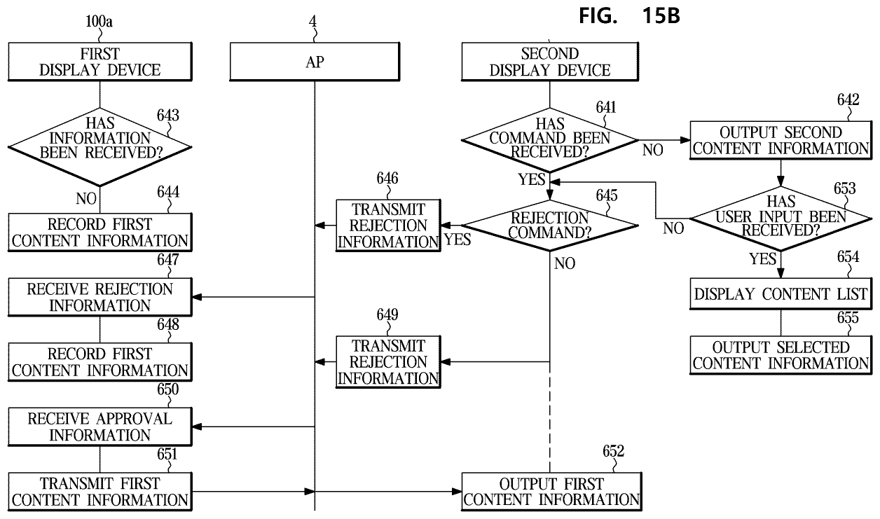

FIG. 15A and FIG. 15B are control flowcharts illustrating content sharing and viewing on display devices of a display system according to an embodiment.

An example where a first display device of a plurality of display devices is set as a main display device is described.

Based on receiving selection information of the main mode through the input 110 or the remote controller 5, the first display device 100a may perform the main mode for content sharing.

Based on receiving content selection information through the input 110 or the remote controller 5 (631), the first display device 100a controls the output of first content information based on the received content selection information (632).

Based on receiving viewing proposal information through the input 110 or the remote controller 5 during the output of the first content information (633), the first display device 100a may display a plurality of sub images corresponding to state information of the plurality of display devices, respectively (634).

Based on receiving viewing proposal information through the input 110 or the remote controller 5 during the output of the first content information (633), the first display device 100a may also display a list of a plurality of display devices connected through the AP 4.

The first display device 100a may move a position of a cursor based on a signal received through the remote controller 5, and based on determining that the moved position of the cursor is a corner of the display of the first display device 100a, the first display device 100a may also display the list of display devices connected through the AP 4.

Based on determining that the moved position of the cursor is a corner of the display of the first display device 100a, the first display device 100a may also display state information of the plurality of display devices connected through the AP 4 as a plurality of sub images.

Based on receiving selection information of a display device through the input 110 or the remote controller 5 (635), the first display device 100a may transmit viewing proposal information to the selected display device (636). In this instance, the viewing proposal information may be transmitted to the selected display device via the AP 4.

Hereinafter, the following description is made based on an assumption that the selected display device is the second display device.

When transmitting the viewing proposal information, the first display device 100a obtains content information being output from the first display device 100a (hereinafter referred to as the first content information) for a preset time, encodes the first content information obtained for the preset time (636), and transmits the encoded first content information to the second display device 100b along with the viewing proposal information.

The first display device 100a may transmit the encoded first content information to the second display device 100b along with EPG information (637).

Based on receiving the viewing proposal information from the first display device, the second display device may display the received viewing proposal information as a popup (638).

Based on receiving a preview command through the input or the remote controller of the second display device (639), the second display device may decode the encoded first content information and display the decoded first content information (640).

Receiving the preview command through the input or the remote controller of the second display device may include selection for a preview button within the popup.

The second display device may display content information being output from the second display device (hereinafter referred to as the second content information) as a main image and display the decoded first content information as a sub image that is superimposed on the main image.

The second display device may also display the second content information on a part of the display of the second display device, and display the decoded first content information on the remaining part of the display of the second display device.

The second display device determines whether the command is received within a reference time from the time of receiving the viewing proposal information through the input or the remote controller of the second display device (641). Based on determining that the command has not been received, the second display device terminates the output of the first content information and outputs only the second content information (642).

The first display device determines whether information about command reception is received from the second display device (643). Based on determining that the information about command reception has not been received, the first display device confirms an end time of the first content based on the EPG information, and records the first content information until the confirmed end time (644).

Here, determining that the information about command reception has not been received may include determining that neither viewing approval information nor viewing rejection information is received through the input or the remote controller of the second display device.

In the embodiment, during content sharing, in order to allow a second user using the second display device to easily recognize what content a first user is currently watching on the first display device, the identification information of content, such as the channel name and program name of the content being output through the first display device, may be transmitted to the second display device along with the encoded first content information.

For example, in a case where home shopping is being broadcast on the first display device and the first user determines that an item desired by the second user is being sold, the first user may make a screenshot of the home shopping being output from the first display device to be captured, or make the home shopping video being output from the first display device to be recorded for a preset time, then encoded and transmitted to the second display device along with the channel name or program name.

As another example, in a case where the first user determines that a documentary liked by the second user is being broadcast on the first display device, the first user may make a screenshot of the documentary being output from the first display device to be captured, or make the documentary video being output from the first display device to be recorded for a preset time, then encoded and transmitted to the second display device along with the channel name or program name.

Based on receiving information about not receiving a command from the second display device, the first display device may also confirm the end time of the first content based on the EPG information, and record the first content information until the confirmed end time.

The second display device may confirm the command received through the input or the remote controller of the second display device, and based on determining that the confirmed command is a viewing rejection command (645), may transmit viewing rejection information to the first display device (646).

Based on receiving rejection information from the second display device (647), the first display device may confirm the end time of the first content based on the EPG information, and record the first content information received from the first display device until the confirmed end time (648).

Based on determining that the confirmed command is a viewing rejection command, the second display device may also record the first content information received from the first display device.

In this case, the second display device may confirm the end time of the first content based on the EPG information, and record the first content information received from the first display device until the confirmed end time.

Receiving the viewing rejection command through the input of the second display device may include selection for a rejection button within the popup.

Based on determining that the command received through the input or the remote controller of the second display device is a viewing approval command, the second display device may transmit approval information to the first display device (649).

Based on receiving the approval information from the second display device (650), the first display device may transmit the first content information to the second display device (651).

Based on receiving the first content information from the first display device, the second display device may terminate the second content information and output the first content information received from the first display device (652).

Receiving the viewing approval command through the input of the second display device may include selection for an approval button within the popup.

The first display device may confirm the end time of the first content based on the EPG information, and transmit the first content information to the second display device until the confirmed time.

Based on the recording of the first content information being completed, the first display device may also transmit the recorded first content information to the second display device.

Based on receiving a signal for a user input from the second display device, the first display device may also transmit the recorded first content information to the second display device.

Based on receiving a user input (653), the second display device may display a popup corresponding to the reception of viewing proposal information or a list of recorded content (654).

Based on receiving a user input, the second display device may display the viewing proposal information of the first display device that was canceled due to an unchecked popup.

The second display device may also confirm the end time of the first content information based on the EPG information received from the first display device, and determine whether a user input is received after the confirmed end time. Based on determining that the user input is received, the second display device may display the viewing proposal information of the first display device that was canceled due to the unchecked popup.

When displaying the viewing proposal information of the first display device, the second display device may display the viewing proposal information together with identification information of the recorded first content, such as program name, channel name, cast, etc., based on the EPG information received from the first display device.

Based on receiving a command to view a list of recorded content within the displayed popup, the second display device may display the list of recorded content, and based on one content being selected through the input, may display the selected content information.

In a case where one content is selected and a playback command is received through the input, the second display device may output the selected content information (655).

Based on receiving an end command through the input, the second display device 100b may terminate the display of the popup on the second display device 100b.

In a case where one content is selected and a deletion command is received through the input or the remote controller of the second display device 100b, the second display device 100b may delete the selected content information. That is, the second display device 100b may delete the content information stored in the memory of the second display device 100b.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be read only memory (ROM), random access memory (RAM), a magnetic tape, a magnetic disc, a flash memory, an optical data storage device, etc.

Although the embodiments of the disclosure have been provided for illustrative purposes, the scope of the disclosure is limited to the embodiments of the disclosure. One or more embodiments that may be modified and altered by those skilled in the art without departing from the principles and spirit of the disclosure, the scope of which is defined in the claims, should be construed as falling within the scope of the disclosure.

1. A display device, comprising:
a display;
communication circuitry configured to communicate with an access point (AP) and a plurality of display devices connected to the AP; and
at least one processor, comprising processing circuitry, individually and/or collectively configured to control the display to display identification information of the plurality of display devices based on received signal strength indicator (RSSI) information of the plurality of display devices received from the AP.

2. The display device of claim 1, wherein the at least one processor is individually and/or collectively configured to obtain distance information between the AP and each of the plurality of display devices based on the received RSSI information of the plurality of display devices, and control the display to display the identification information of the plurality of display devices based on the obtained distance information.

3. The display device of claim 2, wherein the at least one processor is individually and/or collectively configured to identify display positions corresponding to the distance information between the AP and each of the plurality of display devices, and control the display to display the identification information of the plurality of display devices based on information about the identified display positions.

4. The display device of claim 2, wherein the at least one processor is individually and/or collectively configured to control the display to display a plurality of circular guide lines, and to display the identification information of the plurality of display devices on each of the plurality of guide lines based on the distance information between the AP and each of the plurality of display devices,
wherein the plurality of circular guide lines have different diameters, and
wherein a center of the plurality of circular guide lines indicates a location of the AP.

5. The display device of claim 4, wherein the communication circuitry is configured to communicate with a remote controller configured to receive a user input, and
the at least one processor is individually and/or collectively configured to adjust at least one of a location of the identification information of the plurality of display devices displayed on the plurality of circular guide lines based on the user input.

6. The display device of claim 1, wherein the identification information of the plurality of display devices includes at least one of model information, space name information, or device name information of each of the plurality of display devices, and
the at least one processor is individually and/or collectively configured to change the model information of the plurality of display devices to the space name information and device name information based on the user input.

7. The display device of claim 1, wherein the at least one processor is individually and/or collectively configured to control to transmit sharing proposal information to the plurality of display devices, and
among the plurality of display devices, set a display device transmitting sharing approval information as a shareable display device, and set a display device transmitting sharing rejection information as a non-shareable display device.

8. The display device of claim 7, wherein the at least one processor is individually and/or collectively configured to:
based on receiving viewing proposal information for content sharing through an input and/or a remote controller, encode content information output through the display, and control to transmit the encoded content information and electronic program guide (EPG) information to the shareable display device, and
based on receiving viewing approval information from the shareable display device, control to transmit the content information, and based on receiving viewing rejection information from the shareable display device, confirm an end time of content based on the EPG information and record the content information based on the confirmed end time.

9. The display device of claim 1, wherein the at least one processor is individually and/or collectively configured to control the display to display a main image and display a plurality of sub images on the main image, and
each of the plurality of sub images displays state information and identification information of a display device to which each of the plurality of sub images is matched.

10. The display device of claim 9, wherein the at least one processor is individually and/or collectively configured to adjust at least one of a marking, color, brightness, or transparency of the plurality of sub images based on the state information of each of the plurality of display devices, and
wherein the state information includes a shareable state, a non-shareable state, an on state, an off state, and a content output state.

11. The display device of claim 10, wherein the at least one processor is individually and/or collectively configured to confirm a display device being in the on state, confirm a sub image corresponding to the confirmed display device from among the plurality of sub images, and control the display to display content information being output from the confirmed display device on the confirmed sub image.

12. A display system, comprising:
a plurality of display devices; and
an access point (AP) connected to the plurality of display devices,
wherein a display device, of the plurality of display devices, is configured to receive received signal strength indicator (RSSI) information of the plurality of display devices from the AP, and display identification information of the plurality of display devices based on the received RSSI information of the plurality of display devices.

13. The display system of claim 12, wherein the display device is configured to obtain distance information between the AP and each of the plurality of display devices based on the received RSSI information of the plurality of display devices, and display the identification information of the plurality of display devices based on the obtained distance information, and
the identification information of the plurality of display devices includes at least one of model information, space name information, or device name information of each of the plurality of display devices.

14. The display system of claim 13, wherein the display device is configured to:
adjust at least one of display positions of the identification information of the plurality of display devices based on a user input received through an input or a remote controller, and
change identification information of at least one of the plurality of display devices from model information to the space name information and the device name information based on the user input.

15. The display system of claim 13, wherein the display device is configured to:
transmit sharing proposal information to remaining display devices excluding the display device from among the plurality of display devices, set a display device transmitting sharing approval information as a shareable display device, and set a display device transmitting sharing rejection information as a non-shareable display device, and
the remaining display devices are configured to display a popup in response to receiving the sharing proposal information, and transmit the sharing approval information or the sharing rejection information corresponding to a user input to the display device.

16. A method of a display device comprising a display and communication circuitry, the method comprising:
the communication circuitry communicating with an access point (AP) and a plurality of display devices connected to the AP; and
the display device controlling the display to display identification information of the plurality of display devices based on received signal strength indicator (RSSI) information of the plurality of display devices received from the AP.
